(19) United States
(12) Patent Application Publication
(10) Pub. No.: US 2003/0086363 A1
(43) Pub. Date: May 8, 2003

(54) System and apparatus for block segmentation procedure for reduction of peak-to- average power ratio effects in orthogonal frequency-division multiplexing modulation

(76) Inventor: David Hernandez, Westbury, NY (US)

Correspondence Address: Thomas A. O'Rourke, Wyatt, Gerber & O'Rourke, 99 Park Avenue, New York, NY, 10016, US

(21) Appl. No.: 09/871,568

(22) Filed: May 31, 2001

(51) Int. Cl. H04J 11/00

(52) U.S. Cl. 370/208; 370/480

(57) ABSTRACT

An apparatus and system for transmitting user data blocks is disclosed. The apparatus and system includes a means for comparing the peak output of a transmission data block to a constant based on the dynamic range of a power amplifier. For any transmission data block that has a peak output greater than the chosen constant the data block is divided into two or more segments. The segments are transmitted individually to a receiver.

### FIELD OF THE INVENTION

The present invention relates to apparatus, methods and systems for reducing peak to average power ratio effects in orthogonal frequency-division multiplexing modulation.

### BACKGROUND OF THE INVENTION

Orthogonal Frequency Division Multiplexing (OFDM) has, in recent years, received ever-widening interest as a multi-carrier digital transmission scheme because of its simplicity in implementation, high spectral efficiency, and robustness against such channel impairments as multi-path, impulse noise, and fast fading. One key drawback of using OFDM, however, is the magnitude of its peak power relative to the average power of the signal, known as the peak-to-average-power ratio (PAPR). The effects of PAPR typically translate into increased cost in the power amplifier stage. Several techniques have been employed to reduce this metric, each with tradeoffs in data rate and accuracy.

One such approach is found in U.S. Pat. No. 6,104,760 to Wu, which is directed to peak voltage reduction on DMT line driver. In Wu the receiver is notified when clipping is being mitigated by sending “special predefined data”—a “clipping informing frame”. This clipping frame breaks the data to be clipped into a plurality of predefined unclipped frames and sends a message to the receiver for the data that is indicative of the detection and of the predefinition of the frames. Once the predefined frames are sent to a receiver they are converted back to the original incoming data at the receiver. Depending on the implementation of the Wu method, the user may be limited in some way as to the possible information that can be sent. Some method must be used to guarantee that the user does not accidentally send the “special predetermined sequence” and set off inaccurate actions in the receiver. In addition, the Wu method has an impact on throughput. When clipping occurs, the Wu method sends user blocks using two full block transmissions—slowing the data rate by a factor of two—not including the transmission expenditure on the “clipping informing frame”. Additionally, because of the receiver's dependence on this predefined data sequence, the method is highly susceptible to symbol errors caused by erroneous detection of even a single bit of the predefined sequence. Because of this high error rate and the severe throughput impairment caused by the use of this method, the inventors assume the scope of this system's operation to be limited to a clipping probability of approximately 10⁻⁵, tolerating a high PAPR only once in every 100,000 symbol transmissions.

Theoretically, PAPR has no detrimental effects on the effectiveness of an Orthogonal Frequency Division Multiplexing (OFDM) signal. In fact, PAPR may play no role in accurate modulation or demodulation in an OFDM system. The actual implementation of an OFDM transceiver system, however, requires the use of one or more power amplifiers at the output stage of the transmitter. An amplifier efficiently tuned to provide the maximum gain for the average OFDM signal, will experience saturation due to the relatively high peaks in the signal, thereby distorting the signal, introducing spectral regrowth, and reducing the effectiveness of the transmission. Possible remedies for this impairment include:

a. Reduction of the amplifier gain such that the peaks do not cause saturation—“backing off” the amplifier causes a significant reduction in efficiency since the average signal makes no use of the amplifier's extra headroom. This translates to increased cost in the amplification stage, to benefit only a small portion of the signal.

b. Allowing saturation—it has been shown that the OFDM signal peaks may be clipped to certain degrees with tolerable reductions in accuracy as a result. However, spectral analysis of the effects of such clipping shows a significant increase in out-of-band interference. Left untreated, this interference may distort adjacent-channel signals. Because the interference is close to the desired OFDM signal in frequency, filtering the high power RF signal is typically not an option. The filter requirements for the pass and stop band would be too stringent. Removing this interference using signal processing techniques, though possible, increases the cost of RF amplification significantly.

Defining PAPR

An Orthogonal Frequency-Division Multiplexing Signal (OFDM) signal may be represented using the Inverse Fast Fourier Transform (IFFT) of a complex input and Digital-to-Analog conversion to obtain a continuous x(t):

$$x ( t ) = \frac{1}{\sqrt{2 N}} {\sum }_{k = 0}^{N - 1} X [ k ] {ⅇ}^{\frac{j2π k t}{T}} ; 0 \leq t \leq T ; X [ k ] = {a}_{k} + j {b}_{k} = \pm 1 \pm j \qquad ( 1 )$$

Such signal has average power as follows:

$$\begin{matrix}\overline{P} = \frac{1}{T} {\int }_{0}^{T} x ( t ) {x}^{*} ( t ) ⅆ t = \frac{1}{T} {\int }_{0}^{T} [ \frac{1}{\sqrt{2 N}} {\sum }_{k = 0}^{N - 1} X [ k ] {ⅇ}^{\frac{j2π k t}{T}} ] \\ [ \frac{1}{\sqrt{2 N}} {\sum }_{l = 0}^{N - 1} {X}^{*} [ l ] {ⅇ}^{- \frac{j2π l t}{T}} ] ⅆ t \\ = \frac{1}{2 N} {\sum }_{l = 0}^{N - 1} {\sum }_{k = 0}^{N - 1} X [ k ] {X}^{*} [ l ] \frac{1}{T} {\int }_{0}^{T} {ⅇ}^{\frac{j2π ( k - l ) t}{T}} ⅆ t\end{matrix} \qquad ( 2 )$$

Using equation (2) and filling in equation (A7), shown in the Appendix, for the average of a complex sinusoid:

$$\overline{P} = \frac{1}{2 N} {\sum }_{l = 0}^{N - 1} {\sum }_{k = 0}^{N - 1} X [ k ] {X}^{*} [ l ] δ ( ( k - l ) mod T ) = \frac{1}{2 N} {\sum }_{k = 0}^{N - 1} X [ k ] {X}^{*} [ k ] = \frac{2 N}{2 N} = 1 \qquad ( 3 )$$

The peak instantaneous power in the T-length symbol interval may be found as well using the following:

$${P}_{MAX} = \begin{matrix}max \\ 0 \leq t \leq T\end{matrix} x ( t ) {x}^{*} ( t ) = \begin{matrix}max \\ 0 \leq t \leq T\end{matrix} [ \frac{1}{\sqrt{2 N}} {\sum }_{k = 0}^{N - 1} X [ k ] {ⅇ}^{\frac{j2π k t}{T}} ] [ \frac{1}{\sqrt{2 N}} {\sum }_{l = 0}^{N - 1} {X}^{*} [ l ] {ⅇ}^{- \frac{j2π l t}{T}} ] \qquad ( 4 )$$

Therefore, the peak-to-average power ratio of the OFDM signal may be represented as follows:

$$PAPR = {P}_{MAX} / \overline{P} = \begin{matrix}max \\ 0 \leq t \leq T\end{matrix} \frac{x ( t ) {x}^{*} ( t )}{1} \qquad ( 5 )$$

The most instantaneous power will be expended when the peak voltage of each carrier is lined up in time with the peak voltage of all other carriers. Therefore, though this peak instantaneous power is dependent on the data, X[k] (because it modulates the phase of each carrier), the worst case may be calculated:

$$\begin{matrix}{x ( t )}_{MAX , WORST CASE} = \frac{1}{\sqrt{2 N}} {\sum }_{k = 0}^{N - 1} \vert X [ k ] \vert \vert {ⅇ}^{\frac{j2π k t}{T}} \vert = \frac{1}{\sqrt{2 N}} {\sum }_{k = 0}^{N - 1} \sqrt{2} * 1 = \sqrt{N} & ( 6 ) \\ {P}_{MAX , WORST CASE} = {{x}^{2} ( t )}_{max , worst case} = N & ( 7 )\end{matrix}$$

Therefore, the maximum peak-to-average power ratio possible is:

P_{MAX, WORST CASE}/\overline{P}=N (8)

=(10 log₁₀N)dB

Simulations

The purpose behind simulating an OFDM signal is to obtain the PAPR for all possible values of input. These inputs are usually complex and binary:

# possible inputs for length, N, FFT=2^{2N} (9)

The PAPR may be calculated by modulating the N OFDM carriers with the input data and observing the output. However, computer simulations describe discrete systems. It should first be established that it is possible to accurately obtain both the peak power and average power of an analog OFDM signal by describing it in discrete terms.

The present invention preferably makes use of the Inverse Fast Fourier Transform (IFFT) in order to obtain the OFDM signal. The IFFT gives a length N complex output vector for each length N complex input vector. As can be seen from the IFFT's equation:

$$x [ n ] = \frac{1}{N} {\sum }_{k = 0}^{N - 1} X [ k ] {ⅇ}^{\frac{j2π k n}{N}} ; 0 \leq n \leq N - 1 \qquad ( 10 )$$

Each input modulates a particular output complex carrier. Accordingly, one should use the appropriate input data vectors to obtain the amplitude of carriers given in equation (1). The input data vectors preferably, therefore, are defined as:

$$X [ k ] = \pm \frac{N}{\sqrt{2 N}} \pm \frac{N}{\sqrt{2 N}} \qquad ( 11 )$$

Using the FFT, however, results in a discrete output. Therefore, continuous output carrier frequencies are not obtained, but rather, samples of the output carriers are. It is usually not sufficient to find the peak output signal power simply by taking the FFT of the input and finding the maximum x²[n]. Because the FFT usually only provides N uniform samples of the carriers, there may be no guarantee that the samples obtained contain the true maximum. It is therefore important that, regardless of how many carriers one wishes to simulate and what the FFT size is, one should obtain as many samples of the output carriers as is possible. The denser the sample grid is, the more accurate the maximum. This may be accomplished in simulation by using zero-padding using a larger FFT size with unmodulated carriers, thereby increasing the number of samples in the output along with the accuracy of the simulation. See (Porat, Boaz. A Course in Digital Signal Processing. John Wiley & Sons, Inc. 1997, pg. 104) the disclosures of which are incorporated herein by reference.

The following equation relates to determining the accuracy of obtaining average power estimates by discrete simulation. Typically, the samples of the complex sinusoids may be used to calculate the average power of the signal:

$$\frac{1}{T} {\int }_{0}^{T} ( A {ⅇ}^{j k {ω}_{0} t} ) {( A {ⅇ}^{j k {ω}_{0} t} )}^{*} ⅆ t = \frac{1}{N} {\sum }_{n = 0}^{N - 1} ( A {ⅇ}^{j k {ω}_{0} n / N} ) {( A {ⅇ}^{j k {ω}_{0} n / N} )}^{*} \qquad ( 12 )$$

Accordingly, it is possible to calculate the average power of the OFDM signal using sums of discrete samples. As noted above, an N-carrier OFDM signal is defined and shown that its maximum PAPR is equal to N. The effect of this impairment, therefore, depends on the number of carriers used. It is of maximal importance that the practical goal of PAPR reduction—decreasing the cost of the power amplifier stage—be kept in the forefront. Any reduction in PAPR that does not accomplish this goal is of minimal value. Amplifiers are typically defined by their maximum output power. Many techniques which reduce PAPR increase average power. This is true of any coding scheme where more bits are transmitted than those that the user inputs to the system. Those additional bits are susceptible to noise and require increased average signal power in order to maintain the same signal-to-noise ratio per bit throughout the signal. This new, increased average power is the baseline for the newly reduced PAPR. Therefore, the peaks of the coded signal with reduced PAPR may actually be higher than those of the original signal, requiring a more expensive power amplifier. Take, for example, a signal which requires a rate one-half code (twice the output bits as input bits) in order to reduce the PAPR by a factor of two. The reduction of PAPR results in an equal increase in average power. The peaks of both signals would have precisely the same magnitude, and hence, would require the same power amplifier. PAPR is reduced, but the practical goal is not met.

Similarly, it is important in comparing PAPR numbers to realize that these parameters must be considered in light of FFT size. As was pointed out earlier, the FFT size, N, also defines the maximum PAPR for a particular signal. Assuming, for example, that there are two OFDM transmitters that are being compared—a four-carrier system with a PAPR of 4.0, and an eight-carrier system with a PAPR of 4.0. The eight-carrier system has twice the number of carriers, and hence, twice the average power of the four-carrier system. Therefore, though their PAPR's are equal, the eight carrier system will have peaks with twice the magnitude of the four-carrier system. Looking purely at the power amplifier needed for each of these (ignoring throughput considerations), from a cost standpoint, the four-carrier system would most likely be less expensive than the eight-carrier system. Thus, it can be seen that equal PAPR and equal efficiency requirements do not translate to equal cost. While the above examples present a rather simplistic view of transceiver system design, they illustrate important practical considerations which should not be ignored in making theoretical suppositions. In the case of the techniques presented, the goal is to approach the values presented in Simon Shepard, John Oriss, and Stephen Barton. “Asymptotic Limits in Peak Envelope Power Reduction by Redundant Coding in Orthogonal Frequency-Division Multiplex Modulation”. IEEE Transactions Communications, Vol. 46, No. 1, January 1998, as the limits on PAPR reduction for a given redundancy.

Peak Reduction Carriers One possible PAPR reduction scheme suggested in E. Lawrey and C. J. Kikkert. “Peak to Average Power Ratio Reduction of OFDM Signals Using Peak Reduction Carriers”. Fifth International Symposium on signal processing and its applications, ISSPA '99, Brisbane, Australia, Aug. 22-25, 1999, makes use of peak reduction carriers (PRC's)—additional carriers whose modulating coefficients have been pre-selected for optimal reduction of signal maxima. In addition to user information carriers, it is assumed that R* redundant carriers are added to the OFDM signal. By performing an exhaustive search of all possible symbols consisting of both user information and redundant carrier modulation coefficients, the carrier position (frequency), phase, and amplitude may be optimized for low PAPR.

The appropriate modulation coefficients for the peak reduction carriers is maintained in a lookup table. As the user enters information, the appropriate reduction data is looked up and appended to the user data, always in the same carrier positions. The receiver demodulates the signal as usual, simply discarding the information on the redundant carriers (though that data may also be employed for error checking) since the position of the redundant information is known. The authors in Lawrey, above, did not consider the possibility of having peak reduction coefficients instead of redundant carriers (2 coefficients per carrier—real and imaginary), but the system structure would be exactly the same, simply with greater flexibility in choosing the degree of redundancy. Each reduction carrier may be thought of as the addition of two peak reduction coefficients to the system. FIG. 1 gives a block diagram of the OFDM transceiver system using peak reduction carriers. An exhaustive search for optimal reduction coefficients was carried out by the authors in Lawrey, and the resulting OFDM system was shown to have significantly reduced PAPR. However, this search procedure is computationally intensive and, though yielding optimal results, not necessarily practical.

Turning the search itself. For an N carrier OFDM system, assuming complex binary inputs (as defined above), an exhaustive search of all possible symbols is as follows:

2^{2N}=2^{D}# unique symbols for N=D/2 carrier or D bit system (13)

In addition, assuming there are R* peak reduction carriers which may be placed in any position amongst the D* user information carriers (D*+R*=N), there are now D*+R* total data carriers. Since each peak reduction carrier may be placed in any one of the D*+R* available positions, from equation (A1), in the Appendix, the number of unique redundant carrier combinations there may be is:

$$( \begin{matrix}N \\ {R}^{*}\end{matrix} ) = \frac{N !}{{R}^{*} ! {D}^{*} !} \qquad ( 14 )$$

For each one of these possible peak reduction carrier combinations, there are, from equation (13), 2^{2D*} possible user data combinations. This may be represented as:

(_{R*}^{N})*2^{2D*}=# unique user input combinations for N carrier system (15)

For each of these, a search must be performed through all of the possible amplitude and phase modulations for the R* peak reduction carriers. The number of different combinations of amplitude and phase for a single carrier depends on the bit precision of the processor carrying out the modulation. Even for a very minimal number of amplitude and phase possibilities, this can mean thousands of combinations for a small group of reduction carriers. For example, with three peak reduction carriers, each with 10 possible amplitude/phase combinations, the number of carrier possibilities is equal to one thousand (10³), and the search becomes one thousand times as computationally complex as the value given by equation (15). This search can quickly become impractical for widespread use with current technology. As discussed in detail below this search may be appreciably reduced without sacrificing PAPR reduction capability.

Secondly, there is a flaw in the logic that peak reduction carriers as defined above give the best possible PAPR reduction. This may be illustrated with the following example. If N=8 is selected, from equation (13) there are 65,536 possible symbols. If R*=1 is chosen, the symbol space is reduced by a factor of four (because D*=7 carriers), giving 16,384 possible symbols. For each of these, the method of peak reduction carriers finds the reduction carrier amplitudes and phases which give minimal PAPR. Assuming that, for all 16,384 symbol possibilities one is able to find reduction carriers that keep the PAPR below 4.00, this is then assumed to be the best achievable PAPR. However, take the instance that of the 16,384 symbols, one is able to reduce 16,383 of them below a PAPR of 3.00, while the remaining symbol may only be reduced to a PAPR of 4.00. While it is correct that 4.00 is the lowest achievable PAPR given the conditions. It would, however, seem logical that one would not wish to design a power amplifier around a PAPR of 4.00 simply for one symbol. This amplifier backoff would be as undesirable as that caused by the original PAPR problem, itself. Indeed, it might even be desirable to allow a single OFDM symbol to be in error every time it is sent, rather than to limit the efficiency of the amplifier. (In such instance, the error rate would be acceptable, or coding employed in the system could detect the error.)

This would seem to indicate that the method of peak reduction carriers, alone, does not yield the best PAPR reduction. As discussed in detail below, it is shown that, in many cases, a very small group of symbols is resistant to PAPR reduction, and the efficiency of the entire system is sacrificed for those few. In many cases, a lower PAPR may be attainable than one might be led to believe, if only some alternative method could be found to transmit those few symbols for which the PAPR may not be reduced by the reduction carriers. It should be noted that a reduction in data rate or in accuracy may be an acceptable degradation with respect to those symbols due to the fact that they typically represent only a small quantity of the symbol space. Simply put, the system will respond well in most cases, and poorly for a select few. This may be more acceptable, and less costly, than designing for a higher PAPR.

### SUMMARY OF THE INVENTION

The present invention is directed to a method and apparatus for augmenting the PAPR reduction provided by any coding scheme. As described in detail below, the Block Segmentation Procedure of the present invention provides simplicity in implementation and reasonable PAPR versus data rate tradeoff. By augmenting the method of peak reduction coefficients, for example, an appreciably increased PAPR reduction for 4-16 carrier OFDM is obtained. The system of the present invention permits reduced design complexity and cost. Furthermore, the present invention approaches the limit on PAPR reduction with coding as has been described in Simon Shepard, John Oriss, and Stephen Barton. “Asymptotic Limits in Peak Envelope Power Reduction by Redundant Coding in Orthogonal Frequency-Division Multiplex Modulation”. IEEE Transactions Communications, Vol. 46, No. 1, January 1998, the disclosures of which are incorporated herein by reference.

Additionally, the present invention has the benefit of being able to apply to a range of carriers. The Block Segmentation Procedure of the present invention provides benefits for OFDM in the presence or absence of any scheme that makes use of redundant information (coding included), with no limitation on the number of carriers.

In accordance with the present invention there is disclosed a method, system and apparatus for reducing Peak to Average Power Ratio Effects in Orthogonal Frequency Division Multiplexing Modulation. This is achieved by determining which symbols in a symbol space have a PAPR less than some set constant. Then, the symbols in the symbol space that are greater than the constant are determined. For the symbols in the symbol space that are greater than the constant only part of the information bit are transmitted at a time. Zeros are interspersed between those information bits to segregate the bits into blocks.

### BRIEF DESCRIPTION OF THE DRAWINGS

FIG. 1 is a Block Diagram of OFDM Transceiver Implementing Peak Reduction Carriers

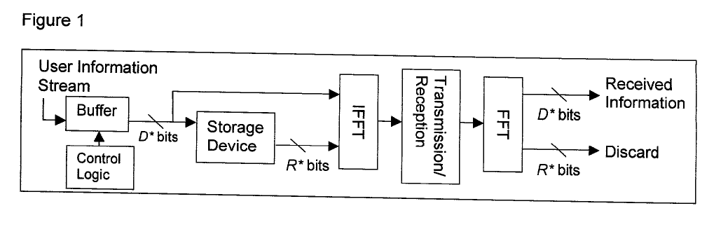

FIG. 2 shows a Block Diagram of OFDM Transceiver Implementing Limit on PAPR Reduction with Coding

FIG. 3 is an Illustration of Symmetry in Placement of Redundant Peak Reduction Bits

FIG. 4 is an Illustration of Block Segmentation Procedure (Segment Length˜½ D)

FIG. 5 is a Block Diagram of OFDM Transceiver with Peak Reduction Coefficients Augmented by Block Segmentation—2 Segments

FIG. 6 illustrates the % Data Rate Reduction vs. PAPR for Block Segmentation (with one bit redundancy) & Peak Reduction Coefficients (coefficients limited to user data specifications)

FIG. 7 illustrates % Data Rate Reduction vs. PAPR for Block Segmentation (with two bit redundancy) & Peak Reduction Coefficients (coefficients limited to user data specifications)

FIG. 8 illustrates % Data Rate Reduction vs. PAPR for Block Segmentation (with three bit redundancy) & Peak Reduction Coefficients (coefficients limited to user data specifications)

FIG. 9 is a Block Segmentation Example—N=4, D=5, R=3

FIG. 10 OFDM symbol error vs. Errors caused purely by Block Segmentation for Unmapped Symbol Detection Method (Threshold=0.53*N/sqrt(2N))

FIG. 11 is a Block Diagram of OFDM Transceiver with Block Segmentation—S Segments

### DETAILED DESCRIPTION OF THE INVENTION

The maximum PAPR for an N-carrier system is N. Many PAPR reduction techniques compare their reduced PAPR to this value. However, the probability of transmitting symbols exhibiting the maximum PAPR in practice is usually quite small; only a select few symbols actually have a PAPR of N. Therefore, a reduction technique may appear to be a great deal more successful then it truly is in practical application.

In this invention, the achievable PAPR reduction, also takes into consideration the data rate sacrifice required to achieve such a reduction. This gives the user the ability to make a fair comparison between reduction techniques. All PAPR schemes cause some degradation in system performance—either in accuracy, or in throughput. In order to make decisions as to how much of a system degradation is acceptable for a set reduction in PAPR, one looks to Shepard supra, where the limit on PAPR reduction was found as a function of data redundancy. Bit redundancy may be considered equivalent to peak reduction coefficient methods if one limits the reduction coefficients only to 180° phase modulation and no amplitude modulation. Essentially, the reduction carrier coefficients are reduced to only those values, which the user information carriers may take on in conventional transmission. For this reason, bit redundancy can never give better performance than the peak reduction coefficient method—The number of possible bit combinations is far less, however, than the number of possible carrier amplitude and phase combinations. With this procedure, as well, an exhaustive list of possible input symbols and their PAPR values is compiled. If one limits the input coefficients for a system to complex binary data (antipodal signaling), the search is limited to 2^{2N} symbols—a value which can be considerably less than in the peak reduction coefficient case. It should be noted that, for antipodal signaling, methods of calculating the PAPR for the complete symbol space are available which take advantage of the structure of the OFDM signal and certain relationships between seemingly independent members of the symbol space. This is investigated in detail in P. W. J. Van Eetvelt, S. J. Shepherd, and S. K. Barton. “The Distribution of Peak Factor in QPSK Multi-Carrier Modulation”. Wireless Personal Communications (Kluwer Academic Press), vol. 2, Nov. 1995

In the case of three subcarriers, because there are two data bits modulating each subcarrier (real and complex bits, respectively) there are, from equation (13), sixty four distinct input combinations. The simulation results are as follows:

TABLE 1
Peak-to-Average Power Ratio Breakdown for Three Subcarrier OFDM

| PAPR | # Symbols |
|---|---|
| 3.0 | 16 |
| 2.61 | 32 |
| 1.67 | 16 |

The maximum PAPR is N, confirming equation (8). Note however, that more than half of the symbols have a lower PAPR. Should one choose to have a redundant data bit in each transmitted symbol (not necessarily in the same bit position every symbol) and reduce the number of usable bits to five, one could reduce the PAPR to a maximum of 2.61.

This is because (restating equation (13)):

2^{# useful data bits}=message space=2^{D} (13b)

The one redundant bit reduces the message space by a factor of two. Certainly, if there are a choice of OFDM symbols, one may then choose to send only that half of the OFDM symbol space with reduced PAPR. Similarly, if one chooses to make two of the six bits redundant, there has been a reduction in the total message space by a factor of four. Since one only needs ¼ of the OFDM symbol space to represent user data, the sixteen user messages should be mapped to the sixteen OFDM symbols that have a PAPR of 1.67, a further reduction. Of importance is the observation that any further addition of redundancy fails to produce a decrease in PAPR. Therefore, if a PAPR of 1.67 is achieved and one is considering decreasing the coding rate further, one could immediately state that the new code would not be optimal. Straight coding cannot achieve a better data rate reduction vs. PAPR tradeoff than the observations given in Lawrey, supra.

The simulation procedure has been carried out for N=2-15 (Table I). Slightly differing results, obtained through simulation, for N=2-8 are shown in Table 2. These calculations provide a baseline for comparison of many different PAPR structures. In addition, there is a verifiable limit on the PAPR reduction available with pure coding. The authors in Shepard conclude that the amount of redundancy required to achieve a PAPR below 3 (4.77 dB) appears to be heuristically converging to a rate % code, or a 25% reduction in data rate. Further data rate reduction becomes inefficient, asymptotically approaching e, the base of natural logarithms, for a rate ½ code or 50% reduction in data rate.

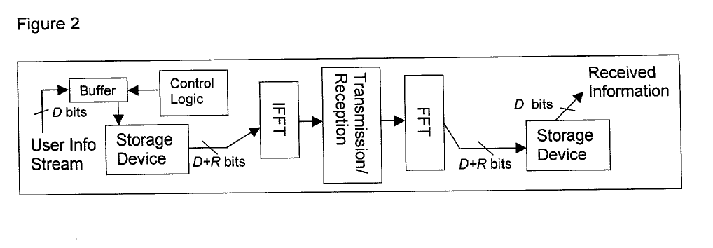

FIG. 2 gives the block diagram of one possible implementation of the system. Note, also, that the storage devices must be larger than those required in the reduction coefficient case because the entire symbol mapping, not just the redundant information, is stored for each input symbol. At the transmitter, the number of stored bits are actually greater than the total amount of bits in the user symbol space. This has the effect of making the storage device far more costly than in the peak reduction coefficient system.

Although PAPR would be reduced the maximum amount possible by any pure coding method, there is an unintended degradation in accuracy caused by direct mapping. Errors are magnified by the reception procedure. Because there is no inherent relationship between the transmitted bits and the original user input bits, an error in the transmitted bits, no matter the number of effected bits, will result in the incorrect reception of the entire symbol. The receiver will be unable to complete the mapping back to the original bits, and there will be no correlation between the output received data and the original user's data. The error rate for this system would most likely be unacceptable in the presence of all but the smallest amount of noise corruption.

Trading Throughput for Power Amplifier Simplicity: The Block Segmentation Procedure

As mentioned previously, the exhaustive search of possible symbols and their PAPR is greatly reduced by limitation of all FFT inputs to complex binary data. Assuming that one chooses to enforce this limitation, the search for the PAPR of every symbol possibility in an N-carrier system will have provided the user with all of the information needed to obtain the optimal reduction coefficient configuration. Assuming there are D data bits per transmitted OFDM signal, the possible combinations of input data bits consist of the binary count from 0 to 2^{D}-1. Therefore, any grouping of D data bit positions, for which all of the binary numbers from 0 to 2^{D}-1 are accounted for among those D bit positions (ignoring the R leftover bit positions) and for which those symbols in the symbol space have a PAPR less than some set constant, fit the definition of a peak reduction coefficient system. Any user data vector would be able to be transmitted simply by directing it to the appropriate D bit positions and appending the appropriate redundant information in the remaining R bit positions.

A search for the existence of symbols which contain binary numbers between 0 and 2^{D}-1 in the same set of D bit positions may easily be carried out by database software, or a high level language program. Similarly, it would not be difficult for such software to return a count of the binary numbers between 0 and 2^{D}-1 which do not satisfy the PAPR criteria. These symbols will be referred to as “unmapped.” Unmapped symbols cannot be reduced to the desired PAPR level using the same reduction coefficient positions as the other, mapped symbols. The unmapped signals require some alternative method of transmission in order to keep the power amplifier requirements as low as possible. As mentioned in above it would be advantageous to find cases where a “good” PAPR reduction is possible for most of the user symbol space (binary numbers 0-2^{D}-1), leaving a few symbols to be transmitted using some other method—more

TABLE 2
Limits on Achievable PAPR with Straight Coding*
(ref. [1] Table 1, Modified Values)

| # Redundant | Number of Carriers | | | | | | |
|---|---|---|---|---|---|---|---|
| Bits | 2 | 3 | 4 | 5 | 6 | 7 | 8 |
| 0 | 2.000 | 3.000 | 4.000 | 5.000 | 6.000 | 7.000 | 8.000 |
| 1 | 2.000 | 2.610 | 2.571 | 2.790 | 3.023 | 3.265 | 3.2984 |
| 2 | 2.000 | 1.667 | 2.001 | 2.243 | 2.715 | 2.6658 | 2.823 |
| 3 | | 1.667 | 1.770 | 2.102 | 2.270 | 2.445 | 2.561 |
| 4 | | | 1.770 | 1.977 | 1.999 | 2.318 | 2.3872 |
| 5 | | | | 1.967 | 1.932 | 2.077 | 2.230 |
| 6 | | | | | 1.912 | 1.949 | 2.001 |
| 7 | | | | | | 1.894 | 2.001 |
| 8 | | | | | | | 1.971 |

mapped symbols than unmapped symbols. Assuming that the data rate reduction or inaccuracy caused by this alternative method for transmitting unmapped symbols was fixed, one would be able to choose a set data rate reduction, and allow the database software to tell inform the user what the corresponding achievable PAPR reduction would be.

There is no limitation on the placement of the redundant bits within the OFDM symbol. However, this provides many combinations to search. A fairly reasonable PAPR reduction may be obtained while putting limitations on redundant bit positions. If all redundant bits are forced to fill into positions one full carrier at a time, the search is simplified greatly. Simply put, if there are an even number of redundant bits, it is assumed that certain entire carriers are modulated by redundant bits (real and imaginary parts), and no carrier is modulated by only a single real or imaginary redundant bit. If there are an odd number of redundant bits, then there will be only one carrier with either real or imaginary redundant bit, but not both.

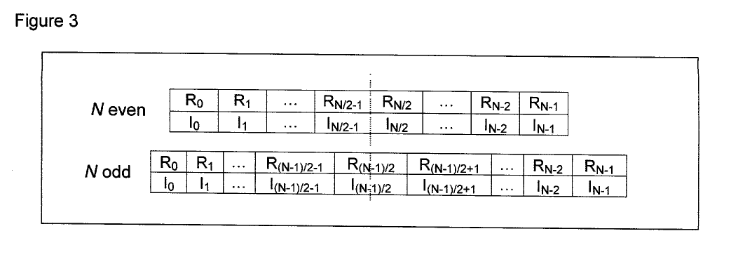

In addition to the reduction in search size obtained by the limitations that have been placed, certain patterns arise in the remaining search. Empirically, the inventor has found certain “symmetries” which allow for a simpler search. These are illustrated in FIG. 3. It is believed that these heuristics are true for all values of N. It has been found that the values hold true for values of N from 4 to 8. Assuming a certain pattern of user data bit positions and redundant bit positions is found to yield a certain number of unmapped symbols at a certain maximum PAPR, it can be shown that:

1. Changing the redundant bit positions from real to imaginary or imaginary to real, within the same carrier, results in the same number of unmapped symbols.

2. Changing redundant carrier positions across the line of symmetry shown in FIG. 3 results in the same number of unmapped symbols.

The following are examples of each of the rules described above. Note that the FFT and IFFT data vectors consist of imaginary and real components—(R₀-R_{N-1}, I₀-I_{N-1}) from most significant to least significant bit.

1.) If R₀, I₃, and R₇ are chosen to be redundant bits and it is found that there are U unmapped symbols for that particular configuration, {I₀, I₃, R₇}, {R₀, R₃, R₇}, {I₀, R₃, R₇}, {R₀, I₃, I₇}, {I₀, I₃, I₇} {R₀, R₃, I₇}, {I₀, R₃, I₇} will all have U unmapped symbols. Only one of these configurations need be confirmed.

2) Take N=6, for example. The line of symmetry is between carriers 2 & 3. Therefore, making bit R₀ redundant will give the same number of unmapped symbols as making bit R₅ redundant. Making bits R₂ & I₂ redundant, will have the same effect as making carriers R₃ & I₃ redundant. Making R₁, I₁, & I₅ redundant will have the same effect as making R₄, I₄, & I₅ redundant. Because of symmetry, once the number of unmapped symbols for a particular redundant bit configuration have been found, the search for the corresponding symmetric bit positions is unnecessary.

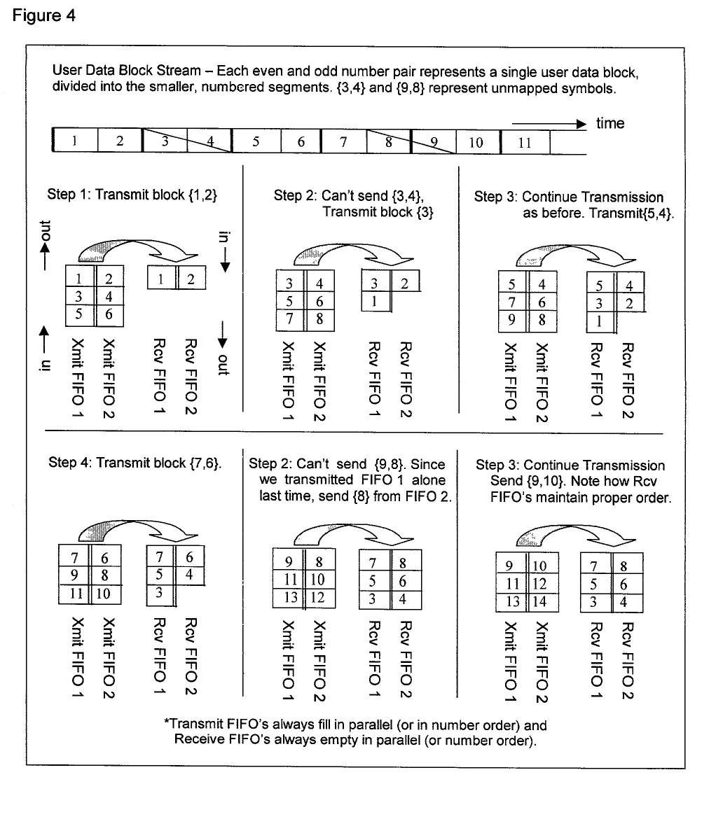

Once it has been determined which redundant bit positions have the least number of unmapped symbols (symbols with higher than desired PAPR), those symbols are transmitted such that they are still recognized as the information the user intended to send in the receiver. Dividing the user's data blocks into smaller segments, it has been found that the smaller segments can be transmitted without any detrimental effects in the power amplifier. The data rate is momentarily slowed (since one is not sending as much information as if the entire user block had been transmitted at once), but the information is conveyed with no loss in error performance and no PAPR-based distortion. Furthermore, the segmentation procedure only incurs a time penalty of half a symbol for each unmapped data symbol—a very efficient way of transmitting the high PAPR data—because the implementation technique allows the user to mix segments from different user blocks in the transmissions (essentially, “packing” the user data as tightly as possible to make the most of the transmitted symbols) without any noticeable difference to the user. FIG. 4 Illustrates this concept.

The numbered blocks shown at the top of FIG. 4 each represent a subset of the user's data blocks (only a portion of the bits to be transmitted)—always obtained from the same bit positions within the block. These represent the segments of the present invention. Each odd and even pair, beginning with {1,2}, {3,4}, etc. represents one full user data block of size D. Three things are of particular importance in order to be effective:

a) It is important that the numbered segments be chosen in such a way that, when sent through the FFT, they do not exceed the requirements of the power amplifier.

b) It is important that the receiver be capable of detecting the difference between transmission of a full user block and simply a single segment.

c) The transmission of segments must be alternated so that one receiver storage device doesn't consistently receive more data than the other storage device and eventually overflow.

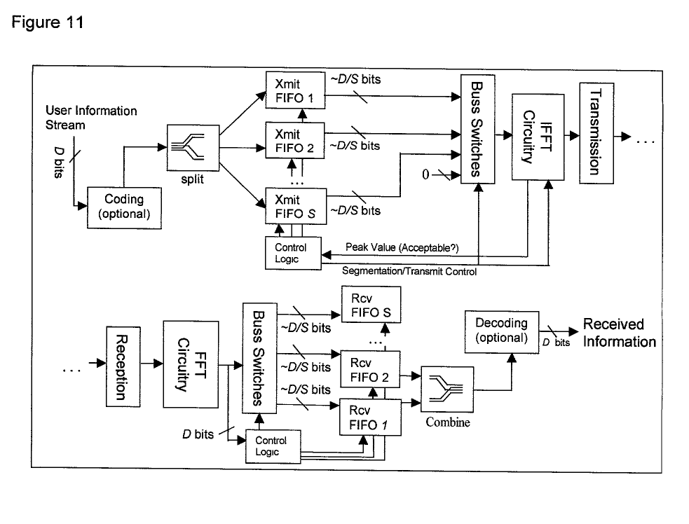

FIG. 11 is a Block Diagram of OFDM Transceiver with Block Segmentation—S Segments Beginning at the transmitter, assume that D user information bits are to be transmitted, and that coding may or may not be used in conjunction with the system. Moving from the top left corner of the diagram to the right—it can be seen that the user data (coded or uncoded) is first split into S segments. Each segment is defined entirely by the bit positions within the user data stream from which that segment's data is obtained. The bit positions assigned to each segment are fixed.

Once the data has been split into the appropriate, predefined groupings, each segment is buffered in its own independent first-in, first-out (FIFO) memory. Whereas conventional systems might make use of a single buffer with D bits per memory slot, this system makes use of S buffers, each with ˜DIS bits per slot (exact size dependant on D being evenly divisible by S). All data blocks are stored in segments, as far as the hardware is concerned, even though they are not necessarily transmitted as individual segments. This allows for the “packing” of data as tightly as possible. To elaborate, when a user data block is found to exceed the PAPR requirements, the system will first transmit only a portion of that data block (with interspersed zeroes to reduce the PAPR), consisting of one or more segments. Whatever the remaining portion of that data block, it must also be transmitted. Rather than fill in zeroes in the bit positions that have already been transmitted from that data block, it is preferable to fill in those portions with actual user data (not necessarily from the same data block). Maintaining all data segmented in separate FIFO memories allows this to be done. The system may transmit OFDM symbols consisting of segments from more than one user data block in order to ensure that the maximum amount of user data that may be transmitted is always done so.

The outputs of the FIFO's are fed to buss switches. These direct the data to the appropriate IFFT bit positions for modulation. For each OFDM symbol, the system first attempts to transmit all S segments (D bits) together. If PAPR requirements cannot be met this way, the buss switches direct only some of the segments to the transmitter, filling in zeroes for those bit positions in the transmitter that don't have data. Note that the segments which are transmitted at this time do not necessarily have to be directed to the same bit positions in the transmitter as they would have been if all S segments had been transmitted. There are cases where it is desirable to have differing transmitter bit positions in order to achieve the best power amplifier efficiency.

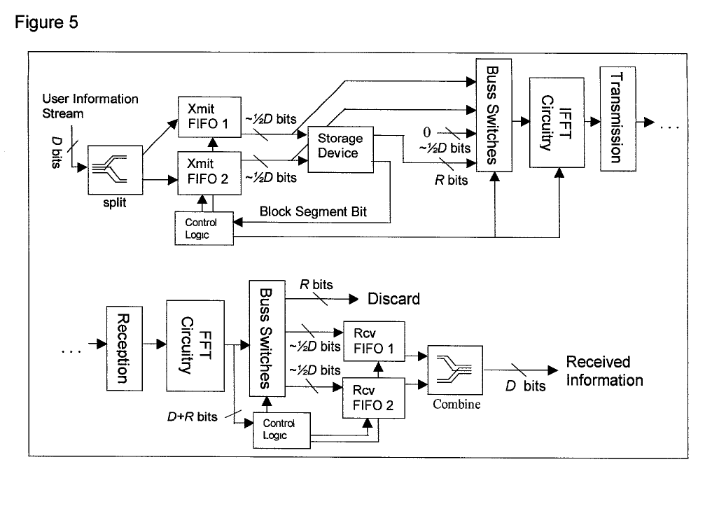

In some systems, it will be possible to ascertain—prior to feeding the data to the IFFT—whether or not power amplifier requirements will be met. Such is the case with the specific system shown in FIG. 5. More generally, however, the peak output of the IFFT will be compared to some threshold in order to determine whether it meets power amplifier requirements. This is achieved through feedback from the IFFT to the control logic. If requirements are met, all S segments may be transmitted. If requirements are not met, only a portion of the FIFO's release data, the buss switches rearrange the data and intersperse zeroes, and the IFFT circuitry uses unmapped mode, which may include increasing the average power fed forward to the power amplifier. This is a design decision. The control logic informs all of these components, when necessary, based on the feedback from the IFFT. It also maintains the “alternation” property in the FIFO's, ensuring that no one FIFO group sends too much information consecutively. Each independent grouping of FIFO's used in unmapped symbol transmission sends data in a fixed cyclic order. No one group transmits unmapped data twice before the other groups have each transmitted unmapped data once.

The output of the IFFT is, at this point, hardly different from in any conventional OFDM system. The only difference is that the inputs defining the characteristics of the OFDM signal have been chosen more deftly. At no time does the signal exceed the requirements of the power amplifier. The power amplifier, itself, is less complex than in other systems, because the requirements have been relaxed. Transmission proceeds as usual. The digital signal is digital-to-analog converted, and shifted to the appropriate frequency range for transmission (using a quadrature modulator) either by wireline or wireless.

Reception occurs as with a typical OFDM system. The signal is shifted down to baseband and analog-to-digital converted. It is then passed through the FFT as is the norm. At this point, the system deviates from typical OFDM, because it must first determine the type of transmission that has occurred—mapped or unmapped—and the position of the user data amongst the output bits before it attempts to estimate and detect the data itself. This initial determination is made using comparators on the FFT outputs which determine whether a single output line contains data or a zero. By looking at these comparators in groups that correspond directly to the positions where user data might be present and assuming the majority of the outputs within a group to reflect the nature of all of the outputs within that group, a determination is made as to how the user data was transmitted and to which bit positions (as opposed to the zeroed bits which contain no useful user data).

Once the control logic has determined the type and position of the user data, normal OFDM detection and estimation takes place—all user data is determined to be either a “1” or a “−1”. (Note that zero is not an option, at this point. It is important to note that the OFDM demodulation error rate has in no way been deteriorated by this system. In fact, in some cases, it is enhanced by the additional average power that may be provided to unmapped symbol transmissions, making the “1” and “−1” more easily distinguishable. The only deterioration to system performance is due to errors in the determination of unmapped vs. mapped symbol transmission. These errors have been proven to cause negligible degradation system performance.)

The buss switches send the appropriate user data bits to the appropriate receiver FIFO. The bit positions of the receiver FIFO's are predetermined, and correspond directly to the bit positions used for segmentation in the transmitter. Therefore, if a segment is transmitted from FIFO X, it will be received in FIFO X.

Because of the “alternation” property in the transmitter, one need not be concerned with the order of received data in the receiver under normal operating conditions. Data may not be received one user block at a time, and segments from multiple user data blocks may be received together in one OFDM symbol, however, at the output of the receiver FIFO's (taken as D parallel bits), the data will arrive in perfect order, with no indication to the user whatsoever that it was sent in any other fashion. Therefore, the segmentation is undone simply with knowledge of which FIFO bit positions correspond to which user data block bit positions (determined by the design of the transmitter and the receiver). This is done, quite simply, by “criss-crossing” the connections appropriately in the receiver design.

At this point, if coding was carried out on the user data prior to transmission, it may be decoded. The final output, under normal operating conditions, will correspond precisely to the original input. Interference, multipath, etc. all degrade normal operating conditions, but the system is as robust against impairments as any other communication system with typical precautionary measures in place.

FIG. 5 illustrates the additional hardware necessary for implementation of the Block Segmentation procedure (with peak reduction coefficients already in place). FIG. 5 represents a specific example of Block Segmentation, as opposed to the more general case studied in FIG. 11 discussed above. Here, it is assumed that Block Segmentation with two segments is used to augment the PAPR effects-reducing quality of the method of Peak Reduction Coefficients (PRC). The PRC method is of particular interest because it is known to provide optimal results amongst coding methods. It differs slightly from typical coding, however, when combined with the Block Segmentation Procedure. In this case, rather than coding all of the user data, the system need only “code” those data blocks transmitted as mapped symbols. The unmapped symbols require no PRC hardware in order to meet power amplifier requirements, and hence, are not coded. This makes the system more efficient, and causes the structure to deviate from the general case shown in FIG. 11. In this case, the “coding” takes place after the user data is segmented in the transmitter FIFO's.

Beginning at the transmitter, assume that D user information bits are to be transmitted with R Peak Reduction Coefficients to be added where necessary. Moving from the top left corner of the diagram to the right—it can be seen that the user data is first split into two segments. Each segment is defined entirely by the bit positions within the user data stream from which that segment's data is obtained. The bit positions assigned to each segment are fixed.

Once the data has been split into the appropriate, predefined groupings, each segment is buffered in its own independent first-in, first-out (FIFO) memory. Whereas conventional systems might make use of a single buffer with D bits per memory slot, this system makes use of two buffers, each with ˜D/2 (exact size dependent on D being even or odd) bits per slot. All data blocks are stored in two segments (in two separate FIFO memories) even though they are not necessarily transmitted as individual segments.

Both FIFO memories first empty into the storage device which holds the reduction coefficient information and a “segmentation” bit. The PRC method is only used for systems with a low number of carriers, making it possible to complete an exhaustive search of every possible user input to the system and calculate the PAPR of the system output. This is done during the design cycle in order to obtain the correct reduction coefficients. In addition, the Block Segmentation system makes use of a “segmentation” bit which is stored along with the reduction coefficients in order to denote those symbols which are determined to exceed power amplifier requirements. Therefore, the user data blocks are used as indexes to look up the appropriate reduction coefficients. If the segmentation bit indicates that segmentation is not required for that particular data block, the data (both segments) is combined with the reduction coefficients and transmitted as usual. If the segmentation bit indicates that segmentation is required, only one segment is transmitted (with interspersed zeroes to reduce PAPR), meeting power amplifier requirements. The remaining segment in that data block must also be transmitted. Rather than fill in zeroes in the bit positions of the previously transmitted segment from that data block, it is preferable to fill in those portions with actual user data (not necessarily from the same data block). Maintaining all data segmented in two separate FIFO memories allows this to be done. The transmission process described above is simply restarted, assuming that the current FIFO outputs (one segment from the current user data block and one segment from the next user data block) contain the next data block to be transmitted. The system may transmit OFDM symbols consisting of segments from more than one user data block in order to ensure that the maximum amount of user data that may be transmitted is always done so.

The outputs of the FIFO's are fed to buss switches. These direct the data to the appropriate IFFT bit positions for modulation. For each OFDM symbol, the segmentation bit, monitored by the control logic, determines what the buss switches transmit. If segmentation is not required, both segments, along with the reduction coefficients, are directed to the IFFT for transmission. If segmentation is required, the buss switches direct only one of the segments to the transmitter, filling in zeroes for those bit positions in the transmitter that don't have data. Note that the segment which is transmitted at this time does not necessarily have to be directed to the same bit positions in the transmitter as it would have been if both segments had been transmitted. There are cases where it is desirable to have differing transmitter bit positions in order to achieve the best power amplifier efficiency. Also, when the IFFT circuitry uses unmapped mode, it may be possible to increase the average power fed forward to the power amplifier. This is a design decision. The control logic informs all of these components based on the segmentation bit. It also maintains the “alternation” property in the transmitter FIFO's, ensuring that no FIFO sends too much information consecutively. No FIFO transmits unmapped data twice before the other FIFO has transmitted unmapped data once. They must always alternate unmapped transmissions to prevent receiver FIFO overflow and to maintain the order of the user information.

The output of the IFFT is, at this point, hardly different from in any conventional OFDM system. The only difference is that the inputs defining the characteristics of the OFDM signal have been chosen more deftly. At no time does the signal exceed the requirements of the power amplifier. The power amplifier, itself, is less complex than in other systems, because the requirements have been relaxed. Transmission proceeds as usual. The digital signal is digital-to-analog converted, and shifted to the appropriate frequency range for transmission (using a quadrature modulator) either by wireline or wireless.

Reception occurs as with a typical OFDM system. The signal is shifted down to baseband and analog-to-digital converted. It is then passed through the FFT as is the norm. At this point, the system deviates from typical OFDM, because it must first determine the type of transmission that has occurred—mapped or unmapped—and the position of the user data amongst the output bits before it attempts to estimate and detect the data itself. This initial determination is made using comparators on the FFT outputs which determine whether a single output line contains data or a zero. By looking at these comparators in groups that correspond directly to the positions where user data might be present and assuming the majority of the outputs within a group to reflect the nature of all of the outputs within that group, a determination is made as to how the user data was transmitted and to which bit positions (as opposed to the zeroed bits which contain no useful user data).

Once the control logic has determined the type and position of the user data, normal OFDM detection and estimation takes place—all user data is determined to be either a “1” or a “−1”. (Note that zero is not an option, at this point. It is important to note that the OFDM demodulation error rate has in no way been deteriorated by this system. In fact, in some cases, it is enhanced by the additional average power that may be provided to unmapped symbol transmissions, as mentioned below, making the “1” and “−1” more easily distinguishable. The only deterioration to system performance is due to errors in the determination of unmapped vs. mapped symbol transmission. These errors have been proven to cause negligible degradation of system performance.)

The buss switches send the appropriate user data bits to the appropriate receiver FIFO. The bit positions of the receiver FIFO's are predetermined, and correspond directly to the bit positions used for segmentation in the transmitter. Therefore, if a segment is transmitted from FIFO X, it will be received in FIFO X.

Because of the “alternation” property in the transmitter, there need not be any concern as to the order of received data in the receiver under normal operating conditions. Data may not be received one user block at a time, and segments from multiple user data blocks may be received together in one OFDM symbol, however, at the output of the receiver FIFO's (taken as D parallel bits), the data will arrive in perfect order, with no indication to the user whatsoever that it was sent in any other fashion. Therefore, the segmentation is undone simply with knowledge of which FIFO bit positions correspond to which user data block bit positions (determined by the design of the transmitter and the receiver). This is done, quite simply, by “criss-crossing” the connections appropriately in the receiver design. Because the peak reduction coefficients are always placed in the same bit positions for transmission, they may be discarded, if they were transmitted (mapped transmission). The final output, under normal operating conditions, will correspond precisely to the original input. Interference, multipath, etc. all degrade normal operating conditions, but the system is as robust against impairments as any other communication system with typical precautionary measures in place.

1) On the Selection of Comparison Groups and Reception:

In general, the number of “numbered comparison groups” will correspond directly to the number of unmapped transmission possibilities there are. If there are X different ways to transmit an unmapped symbol, then there will be X numbered comparison groups—each including the bit positions dedicated to data for each transmission possibility. For example, in the system of FIG. 5, there are two segments and exactly two unmapped symbol transmission possibilities. Therefore, the bit positions dedicated to one of the segments (for unmapped transmission) are selected as one “numbered comparison group” and the bit positions dedicated to the opposite segment are selected as the other “numbered comparison group”.

In many cases of OFDM transmission with coding, the total number of bit positions dedicated to unmapped symbol transmission are not equal to the number of bits the system is capable of transmitting. This is because there are more coded bits than there are user data bits per block during mapped transmission, but the coding may not be applied for unmapped transmission. For example, in the system of FIG. 5, there may be R additional peak reduction coefficients which must be transmitted with mapped symbols in addition to the D user data bits. Therefore, it may be the case that the numbered comparison groups do not account for all of a system's bit positions. Any additionally bit positions are independent from unmapped symbol information and are, therefore, selected as the “common comparison group”.

In general, the determination of transmission type (unmapped vs. mapped) and position (which bits are user data) is carried out as follows:

1. The receiver observes the numbered comparison groups and determines which of the groupings appears to contain the most non-zero data bit positions. (If more than one group is tied for the maximum, the receiver selects from the tied groups at random.) The receiver will concentrate on proving or disproving that the group containing the majority of information (receiver outputs exceeding the threshold, T) represents unmapped transmission information. This is the initial hypothesis.

2. The receiver examines the bit positions presumed to contain information—the chosen numbered comparison group. If these positions contain a majority of zeroes (outputs below T), the hypothesis is assumed to be incorrect. Presumably, noise has corrupted a mapped symbol so that several of the information bits are erroneously below the threshold. The receiver detects a mapped symbol.

3. The receiver examines the bit positions presumed to contain zeroes—all of the remaining numbered comparison groups and the common comparison group. If these positions contain a majority of information bits (outputs above T), the hypothesis is assumed to be incorrect. Presumably, noise has corrupted a mapped symbol so that several of the information bits are erroneously below the threshold. The receiver detects a mapped symbol.

4. If neither test disproves the original hypothesis—there is a majority of information bits where it is assumed there should be information and a majority of zeroes where it is assumed there should be zeroed bits—then, the receiver detects an unmapped symbol and has determined which of the alternating positions contains the information. The receiver detects an unmapped symbol in the position of the numbered comparison group selected initially.

2) Power Amplifier Headroom During Unmapped Symbol Transmission:

Though much literature has been dedicated to studying “amplifier efficiency”, and there are quantitative measures of efficiency available, PAPR's effect on power amplifier design in the case of OFDM may be summed up in less complex terms. Simply put, it is undesirable to be forced to design a power amplifier capable of handling a certain level of signal peak at the input when all other values of the signal are far lower and far less taxing on the amplifier. If the signal peaks could be reduced, then the amplifier would not have to be designed to accept this dynamic range and the new amplifier would most likely have decreased cost. Stated this way, it can be deduced that PAPR is not the only metric of importance when discussing power amplifier cost and complexity.

This can be related directly to typical Block Segmentation unmapped symbol transmissions. When, rather than sending a full user data block, only a portion of the user data block is sent with interspersed zeroes, it is assumed that PAPR is reduced. If, rather than transmitting D data bits, DIS data bits are sent, the average transmitted power is reduced by a factor of S (because the number of carriers being modulated with real and imaginary coefficients is reduced by a factor of S). Since the input signal peak which the system's power amplifier can tolerate without distortion is a constant, an interesting effect may be exploited. Assuming that the PAPR for unmapped symbol transmissions is no worse than for mapped transmissions (this is usually the case), note that the reduction in average power by a factor of S means that unmapped symbol peaks would then have been reduced from mapped symbol peaks by at least a factor of S (or the PAPR would not be less than that for the mapped case). This means that the power amplifier could actually handle a signal S times greater than the peak of any unmapped symbol. This has a variety of consequences, including:

1. Because it has been shown that the power amplifier requirements are not as susceptible to being exceeded by the unmapped symbols as by the mapped symbols, in actuality, unmapped symbol transmissions may have at least S times greater a PAPR as mapped transmissions without any distortion taking place in the power amplifier. (This is a lower bound because unmapped symbols can actually carry less redundant information than mapped symbols, and may therefore be even smaller than [mapped transmission length/S])

2. Because unmapped symbol PAPR is typically less than mapped symbol PAPR, it is usually possible to increase the average power for unmapped symbol transmissions by a factor of S without exceeding power amplifier requirements. This can give a significant OFDM error performance increase for unmapped symbols, thereby decreasing the overall bit error rate of the system.

In addition to the typical redundant information stored for the method of peak reduction coefficients, an additional “block segment” bit is stored which is used to signify those symbols which require segmentation in order to meet the power requirements of the power amplifier.

Inherent to all FFT and IFFT circuitry is some very simple mapping from {1} and {−1} bits to some predetermined symbol—typically the largest positive and negative numbers available with the FFT or IFFT's bit precision. This gives the FFT process the best possible signal resolution (more bits allow it to describe the signal in finer detail). Similarly, in the receiver, some decision is made as to whether a particular output number represents a {1} or a {−1} (typically based solely on the sign of the data output by the FFT) and only those two possibilities are accepted as outputs.

Buss switches provide a dynamic mechanism for directing data to the appropriate bit positions in both the transmitter and receiver. This is necessary because, for mapped data, the FFT/IFFT bit positions used by the first-in, first-out (FIFO) memories will not necessarily be the same as the bit positions used for unmapped data. The reason for this will be made clear in section VII. These switches allow redirection of the data as appropriate. For the structure suggested in this paper, there are only two possible configurations of the buss switches (each input/output is connected to only one of two possibilities at any one time), making the hardware simple and cost efficient.

Once the segments have been determined to have appropriate PAPR tolerances and that they can be properly detected in the receiver, the throughput for such a system can be calculated. This is important because there may be a point at which the reduction in data rate caused by sending segments instead of the entire user block become so detrimental as to make the addition of Block Segmentation undesirable? Ascertaining the effective data rate of the system permits a comparison to the data rate of a system without Block Segmentation. Then, an informed decision can be made as to whether the reduction in data rate is worth the additional reduction in PAPR. The effective data rate for a Block Segmentation OFDM system with two segments per user block. (Two segments per user block are used throughout this paper, but Block Segmentation can function with any number of segments.) can be defined:

$$effective data rate = \frac{user symbol space * \# useful info bits}{user symbol space + \# unmapped symbols * 1.5} = \frac{{2}^{D} * ( D )}{{2}^{D} + U * 0.5} \\ where \text{:} \begin{matrix}D = \# useful information bits \\ U = \# unmapped symbols\end{matrix} \qquad ( 16 )$$

### EXAMPLE

Assume the system has N=8 carriers, R=4 bit redundancy, 2N-R=D=12 useful data bits, and U=384 unmapped symbols out of a possible user symbol space, from equation (13), of 2^{D}=4096. If it is assumed that an 8-point FFT takes 1 second, the maximum possible data rate achievable with this FFT is 2*N=16 bits/second. The data rate will never achieve this value because only D=12 bits of the data bits carry actual user information. Assuming that the distribution of messages holds rigidly (which they should over a long data stream if the data bits are independently distributed), if 4096 messages are sent, 384 of them will be unmapped, requiring not simply an FFT, but 1.5 FFT's to transmit. Therefore, the number of FFT's required to transmit the 4096 messages is (4096-384)+384*1.5=4288 FFT's. Given 1 FFT/second, this translates to 4288 seconds to transmit all of the information. The number of data bits sent are 4096*12 bits=49152 bits. The resultant data rate is, therefore, 49152 bits/4288 seconds=11.462 bits/second. The data rate has therefore been reduced to 71.64%. Equation (16), above, is an algebraic simplification of the logic given here and yields the same conclusion.

Data Rate Reduction vs. PAPR

The results are given as functions of relative bit redundancy and percentage of the maximum data rate. The following is a comparison the data rate reduction versus PAPR for both peak reduction coefficients alone and with Block Segmentation.

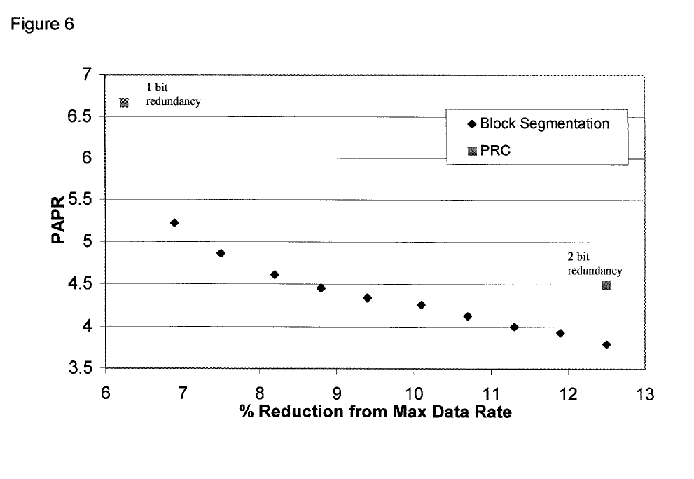

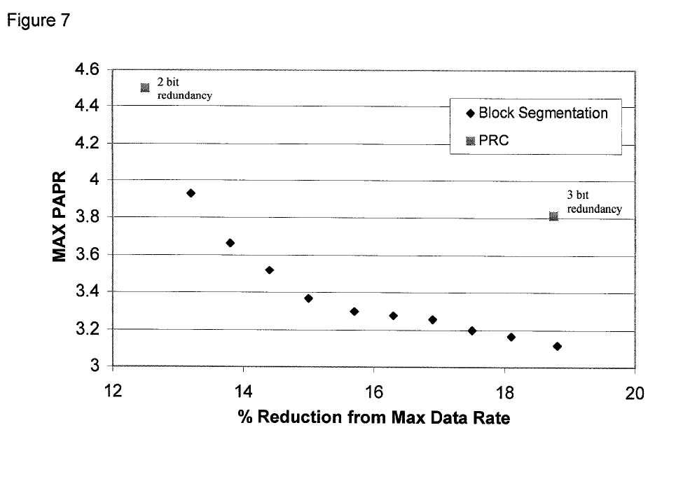

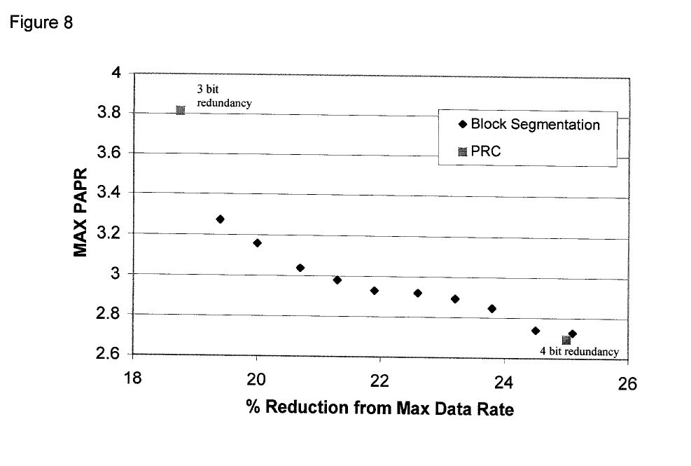

To clarify the information in FIGS. 6-8, it is assumed that the achievable PAPR for N=8 with Block Segmentation using 1, 2, & 3 redundant bits, respectively. Because Block Segmentation reduces the data rate by varying amounts depending on the number of unmapped symbols transmitted, the “% reduction in Max Data Rate” specification overlaps from one chart to the next. For example, with one bit redundancy (FIG. 6), there can be such a large number of unmapped symbols that, rather than having a data rate reduction of 1/16 (1 redundant bit out of 16) or 6.25% from the maximum, a PAPR of 4.501 can be achieved with the equivalent of two redundant bits—12.5% reduction from the maximum data rate. This does not, however, mean two redundant bits with each symbol are being sent. The performance for that case is shown in FIG. 7.

The pattern seen in FIG. 6 and FIG. 7 is present for varying values of N and R. Peak reduction coefficients give a PAPR reduction, but Block Segmentation gives a further reduction with only a small sacrifice in data rate. The “exponential” shape of the data rate reduction vs. PAPR curve indicates that a larger decrease in PAPR occurs with small data rate sacrifices initially (with respect to reduction coefficients) than is capable with increasingly larger data rate reductions below that. It is logical that the “knee” of the curve is the point of maximum efficiency, providing the largest PAPR reduction for the most efficient data rate sacrifice. Table 3 shows some further statistics for Block Segmentation versus peak reduction coefficients (coefficients limited to user data specifications). The “exponential” nature of the data rate reduction versus PAPR curve is taken advantage of in this table, which gives values for Block Segmentation which are in the “knee” of the curve—at the point of adding approximately one half bit of redundancy to the method of peak reduction coefficients. In all cases but one, the ½ bit of redundancy added by Block Segmentation (clear rows) moves the PAPR closer to that obtained with more data rate reduction using peak reduction coefficients (shaded rows) than less data rate reduction. Take, for example, the second row of Table 3. In this case, Block Segmentation gives a PAPR of 2.801. Its closest neighbor is a PAPR of 2.680 attainable using peak reduction carriers. It's next higher neighbor using peak reduction coefficients yields a PAPR of 4.087. Block Segmentation yields a value much closer to the lower value of PAPR than the higher, but looking at the reduction in data rate, the sacrificed throughput is actually half way in between the two. This means that using the present invention only half as much throughput is sacrificed to get to about the same low PAPR value as one would be forced to sacrifice using peak reduction coefficients. Furthermore, there is far greater flexibility in choosing the data rate reduction one may be willing to tolerate. The smallest data rate reduction step with peak reduction coefficients is one bit. Block Segmentation gives a much finer control over the data rate reduction vs. PAPR tradeoff.

TABLE 3
Performance Examples for Two-Segment Block Segmentation (clear rows)
vs. Peak Reduction Coefficients (shaded rows)

| | Actual | Relative | Throughput | |
|---|---|---|---|---|
| | Redundancy | Redundancy | as % of Max | Max |
| N | (bits) | (bits) | Data Rate | PAPR |
| 5 | 1 | 1 | 90.0 | 4.087 |
| 5 | 1 | 1.53 | 84.7 | 2.801 |
| 5 | 2 | 2 | 80.0 | 2.680 |
| 5 | 2 | 2.48 | 80.0 | 2.601 |
| 5 | 3 | 3 | 70.0 | 2.243 |
| 5 | 3 | 3.42 | 65.8 | 2.113 |
| 6 | 1 | 1 | 91.6 | 5.033 |
| 6 | 1 | 1.46 | 87.8 | 3.673 |
| 6 | 2 | 2 | 83.3 | 3.029 |
| 6 | 2 | 2.45 | 79.6 | 2.850 |
| 6 | 3 | 3 | 75.0 | 2.774 |
| 6 | 3 | 3.53 | 70.5 | 2.391 |
| 7 | 1 | 1 | 92.8 | 5.775 |
| 7 | 1 | 1.51 | 89.2 | 3.891 |
| 7 | 2 | 2 | 85.7 | 3.588 |
| 7 | 2 | 2.50 | 82.1 | 3.078 |
| 7 | 3 | 3 | 78.5 | 3.058 |
| 7 | 3 | 3.50 | 75.0 | 2.666 |

It is also important to note that Block Segmentation in no way limits the coding scheme used with it. In this case, the use of peak reduction coefficients limited to the user data specifications has been shown. However, there is nothing to prevent one from using peak reduction coefficients that modulate the amplitude and phase of the carriers as well. The foregoing illustrates a relatively simple technique, and in limiting the coefficients, the size of the initial search has been greatly reduced. These numbers are not being presented as the best PAPR reduction possible, but rather as an example of a good tradeoff between simplicity and performance. It is left up to one skilled in the art to decide whether the additional PAPR reduction is needed.

Finally, data for N=4 is not given, but it is important to mention that a maximum PAPR of 2.00 is achievable with two redundant bits using the method of peak reduction coefficients. This is low enough that further reduction and additional hardware complexity is of little use. This is the one case where the limit could be met with no sacrifice in error probability.

Segmentation Effect on Unmapped Symbol Peaks

What block segmentation does to unmapped symbols is it transmits only a part of the information bits at a time, and intersperses zeroes between those information bits. Equation (8) states that any OFDM signal has a limit on the maximum PAPR which depends on the amount of information being transmitted. (Essentially, the more carriers used, the higher the peak power.) The partial transmission of the present invention reduces the number of used carriers, and therefore, the peak power. Additionally, the interspersed zeroes guarantee that certain in-phase configurations of the carriers can never occur. These are the root causes of high PAPR and, therefore, are eliminated in unmapped transmissions. This is referred to as “symbol space expansion” since the user symbol space is being taken and stretched over more carriers without the addition of more symbols. Finally, in reducing the number of modulated carriers, the average power in the signal is reduced. Therefore, even if the PAPR of the signal was as high as with conventional transmission (or, in some cases, higher), the decrease in average power by more than a factor of two (in the case of two segments) guarantees that the peaks will be a factor of two less than with conventional transmission—making it unlikely that unmapped transmissions will exceed the tolerances of the power amplifier. PAPR reduction is not the goal. Power amplifier simplicity is what is sought to be achieved. At times, the two are mutually exclusive.

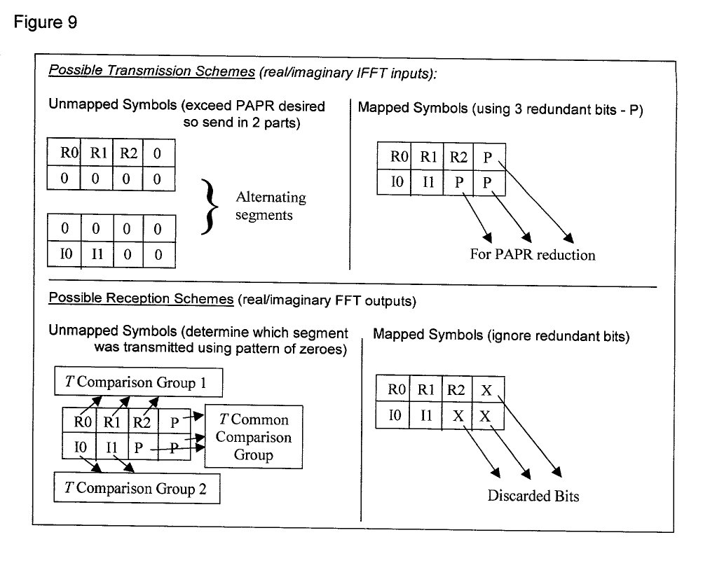

Tables 4 & 5 related to the unmapped symbols' method of transmission. Table 4 gives the suggested block segment sizes (approximately D/2 for two-segment systems) for varying bit redundancies and number of carriers. These appear to be the simplest block sizes to implement and allow one to use the symbol space expansion technique, which ensures that the PAPR remains low even for unmapped symbols. The PAPR achievable using a particular expansion method—filling in only the real input bits or only the imaginary input bits of the IFFT—is given in table 5. This is referred to as “staggered” configuration since it fills in every other bit with user data from a single segment until it is expended, as shown in FIG. 9. This is one of the simplest methods of signal expansion to use since the alternate transmitted segments will be equivalent in PAPR values. (The relationship between subcarrier phases is the same for both—one signal is a phase shift of the other.)

TABLE 4
Block Segment Sizes Suggested (bits) for Two-Segment Systems

| | |
|---|---|
| Bit | Number of Carriers(N) |

| Redundancy | 5 | 6 | 7 | 8 |
|---|---|---|---|---|
| 1 | 5, 4 | 6, 5 | 7, 6 | 8, 7 |
| 2 | 4 | 5 | 6 | 7 |
| 3 | 4, 3 | 5, 4 | 6, 5 | 7,6 |
| 4 | 3 | 4 | 5 | 6 |

*Two sizes needed for odd length blocks

TABLE 5
Maximum PAPR using Staggered Symbol Space Expansion Technique

| | |
|---|---|
| Block Size | Number of Carriers(N) |

| (bits) | 5 | | 6 | 7 |
|---|---|---|---|---|
| 4 | 1.601 | 1.334 | | |
| 5 | 2.501 | 2.084 | 1.786 | |
| 6 | | 3.001 | 2.572 | 2.251 |
| 7 | | | 3.501 | 3.063 |
| 8 | | | | 4.001 |

This table shows that in many systems, the use of redundant bits are not required at all when sending unmapped data symbols. Symbol space expansion should be enough to meet amplifier requirements. It is important to note that the PAPR parameter for unmapped symbol transmission has a different meaning in the context of the power amplifier than the PAPR for mapped symbol transmission. The average power in the case of unmapped symbols will be less than half that of the mapped symbol case. Therefore, from Table 5, above, and the factor of two headroom in the power amplifier, this unmapped symbol PAPR should not be a limiting factor in any of the transmission schemes. Regardless, the PAPR may be further reduced when necessary.

### EXAMPLE

For N=8, with 3 redundant bits, a PAPR of 2.9286 may be attained with 3.50 relative bit redundancy (3 bit redundancy+Block Segmentation). However, table 4 shows the suggested block segments as having lengths of 6 and 5 bits, respectively. Table 5 shows that one can attain this PAPR using staggered symbol space expansion with the length 6 block, but not the length 7 block. Therefore, the staggering method mentioned above is not used, and rather the system is designed to transmit one of two combinations of 0 bits-{10, 11, 12, 13, 14, 15, 16, R6, R7=0} or {R0, R1, R2, R3, R4, R5, R6, 16, 17=0}. This reduces the PAPR with 7 transmitted data bits and 9 unmodulated bits to 2.627, and allows one to achieve the desired PAPR with the desired data rate and still have sufficient headroom in the power amplifier for unmapped transmission (a factor of two).

It is always desirable to have as many zero bits in each transmitted symbol as possible. For this reason, approximately half of the unmapped symbol information bits should be transmitted at a time. This guarantees that, regardless of which segment (which first-in, first-out memory) is transmitted, approximately the same number of zero bits will be transmitted.

Error Performance

Since the OFDM modulation structure has not been modified, the performance of the system is the same as for any typical N channel OFDM system, with a slight exception—The transmission of unmapped symbols depends on the receiver's ability to detect the change from mapped symbol transmission to the alternate mode. It is desirable that the error rate in detecting this change be far below the error rate for the OFDM data transmissions, themselves. If this is so, then the overall error performance of the Block Segmentation system will be comparable to straight OFDM. Therefore, the procedure will be capable of being compared directly to any other OFDM transmission scheme, without bias.

ANALYSIS—There are two ways in which unmapped symbol transmission can cause errors:

Error Type 1: an unmapped symbol (zeroed bits) is transmitted, but the receiver detects a mapped symbol (all bits used).

Error Type 2: a mapped symbol (all bits used) is transmitted, but the receiver detects an unmapped symbol (zeroed bits).

Note that, because the example is a two-segment case, the positions of the zeroed bits are alternated during unmapped symbol transmission and two positional configurations of zeroed bits are sought, independently, in the receiver. There are, therefore, two possible ways for each of the error types given above to occur (see FIG. 9).

Assuming that all receiver bit positions have a set threshold, T, magnitude below which a zero is assumed to have been transmitted and look at the performance of the above cases. T should lie between zero and the magnitude of the IFFT coefficients. There are three possibilities which the receiver must distinguish between:

1) Mapped Symbols: The transmitter sends a full OFDM symbol containing peak reduction bits. The receiver must ignore the peak reduction bits and send the appropriate information bits to their appropriate bit positions in the receive FIFO memories.

2) Unmapped Symbol, Position 1: The transmitter uses a partial OFDM symbol. Certain transmitted bits contain information, while others contain zeroes. The position of the information bits is predetermined and distinct from position 2, below. The information bits are stored in the appropriate receive FIFO memory.

3) Unmapped Symbol, Position 2: The transmitter uses a partial OFDM symbol. Certain transmitted bits contain information, while others contain zeroes. The position of the information bits is predetermined and distinct from position 1, above. The information bits are stored in the appropriate receive FIFO memory.

Two independent unmapped information positions are preferred in order to avoid overflow in either of the receive FIFO's. By alternating which of the receiver's FIFO memories receives unmapped symbols, prevents any one of them from attempting to store too much data. A possible configuration of these possibilities for four carriers and three redundant bits is shown in FIG. 9.

In order to determine, in the receiver, which of the three transmitter possibilities has occurred, the following steps may be executed (based on the basic structure illustrated in FIG. 9):

5. First the receiver observes the two groupings of unmapped symbol information bits (numbered comparison groups). If one of the groupings appears to contain more zeroes than the other grouping the receiver will concentrate on proving or disproving that the group containing the majority of information (receiver outputs exceeding the threshold, T) represents unmapped transmission information.

6. The receiver examines the bit positions presumed to contain information—one of the numbered comparison groups. If these positions contain a majority of zeroes (outputs below 7), the hypothesis is assumed to be incorrect. Presumably, noise has corrupted a mapped symbol so that several of the information bits are erroneously below the threshold. Receiver detects mapped symbol—disregard redundant bit positions and store user data positions in both FIFO's.

7. The receiver examines the bit positions presumed to contain zeroes—one of the numbered comparison groups and the common comparison group. If these positions contain a majority of information bits (outputs above T), it is assumed the hypothesis to be incorrect.

Presumably, noise has corrupted a mapped symbol so that several of the information bits are erroneously below the threshold. Receiver detects mapped symbol—disregard redundant bit positions and store user data positions in both FIFO's.

8. If neither test disproves the original hypothesis—i.e., one has a majority of information bits where it is assumed there is information and a majority of zeroes where it is assumed there are zeroed bits—then, the receiver detects an unmapped symbol and has determined which of the alternating positions contains the information. Disregard all else and store the user data positions in one of the receiver FIFO's.

Complicated as this procedure may appear, it depends merely on comparison to a threshold at each individual bit position. This entire procedure may be implemented in hardware using comparators and simple logic gates to form majority decoders. It is also advantageous that the most time-consuming part of the procedure—comparison to the threshold—may be carried out in parallel. Once the detection procedure has been performed, the probability of error in the presence of noise may be determined. The final expression is simplified greatly by making a simple assumption. It will be assumed that the initial choice between numbered comparison groups (step 1, above) is correct enough of the time so as not to contribute a significant amount of the error to the system. This initial step is meant to prevent erroneous detection by ruling out the possibility of detecting both unmapped symbol possibilities at the same time. As shown by simulation, including the error probability for this step analytically has little effect on the accuracy. The full detection procedure was simulated for comparison.

For purposes of this embodiment, it is assumed that the first step has been completed and that there is a choice between mapped symbol detection or unmapped symbol detection only. As stated above, there are two basic types of errors. Within those two types, there are further subdivisions. Initially, the first type of error will be addressed—detecting a mapped symbol when an unmapped transmission was sent.

Error Type 1: There are two ways to erroneously detect a mapped symbol (all bits used) in the receiver.

In the bit positions of the received signal vector which are supposed to be zeroed out (one numbered comparison group and common comparison group), a majority of the bits exceed the threshold.

In the bit positions of the received signal vector which are supposed to contain information (alternate numbered comparison group), a majority of the bits are below the threshold.

In order to analyze these two situations there is a need to know the probability that a transmitted zero bit exceeds a magnitude of T and that a transmitted 1 or −1 bit falls below a magnitude of T in the receiver. Looking at a single subcarrier, k, the transmitted signal is, from equation (1):

$${x}_{k} ( t ) = \frac{\{ 1 , - 1 \}}{\sqrt{2 N}} {ⅇ}^{\frac{j2 π k t}{T}} + j \frac{\{ 1 , - 1 \}}{\sqrt{2 N}} {ⅇ}^{\frac{j2 π k t}{T}} ; 0 \leq k \leq N - 1 \qquad ( 17 )$$

The real part of equation (17) represents one transmitted bit and the imaginary part another bit. These are demodulated in the receiver, using the FFT on N uniformly-spaced samples of the transmitted signal:

$${x}_{k} [ n ] = \pm \frac{1}{\sqrt{2 N}} {ⅇ}^{\frac{j2 π k n}{N}} \pm j \frac{1}{\sqrt{2 N}} {ⅇ}^{\frac{j2 π k n}{N}} ; 0 \leq k \leq N - 1 \qquad ( 18 )$$

Calculating the energy of a single carrier:

$$\text{Energy per carrier} = {\sum }_{n = 0}^{N - 1} {x}_{k} [ n ] \cdot {x}_{k}^{*} [ n ] = {\sum }_{n = 0}^{N - 1} ( \pm \frac{1}{\sqrt{2 N}} {ⅇ}^{\frac{j2π k n}{N}} \pm j \frac{1}{\sqrt{2 N}} {ⅇ}^{\frac{j2π k n}{N}} ) ( \pm \frac{1}{\sqrt{2 N}} {ⅇ}^{- \frac{j2π k n}{N}} ∓ j \frac{1}{\sqrt{2 N}} {ⅇ}^{- \frac{j2π k n}{N}} ) = {\sum }_{n = 0}^{N - 1} ( \frac{1}{2 N} + \frac{1}{2 N} ) = 1 \qquad ( 19 )$$

Therefore, the total energy in the signal is given as:

Eₛ=Energy per carrier·N carriers=E_{b}·2N bits (20)

Essentially, the FFT carries out a samplewise correlation to the conjugate of the complex exponentials given in equation (18), yielding the output data, Y[k] (also known as “matched filtering”):

$$Y [ k ] = {\sum }_{n = 0}^{N - 1} {x}_{k} [ n ] {ⅇ}^{- \frac{j2π k n}{N}} ; 0 \leq k \leq N - 1 \qquad ( 21 )$$

Combining equations (18), and (21):

$$Y [ k ] = \pm \frac{N}{\sqrt{2 N}} \pm j \frac{N}{\sqrt{2 N}} ; 0 \leq k \leq N - 1 \qquad ( 22 )$$

It becomes clear that, in the absence of signal distortion, the precise input data—equation (11) is obtained. If a zero bit is sent, a zero bit would be received. The same is true for transmitted user data. The unmapped symbols would be clearly distinguishable from the mapped symbol transmissions using any threshold, T. which lies between 0 and N/sqrt(2N).

If it is assumed that the transmitted signal vector is corrupted by nₖ(n)—Gaussian white noise with zero mean and variance=σ². For a single bit the received signal on subcarrier k would be a combination of the transmitted bits and the noise. Looking at only the one quadrature component of the transmitted vector, it can be shown that the noise affecting this component has parameters equivalent to the noise given above—Gaussian, white, zero mean, variance=σ²—simply by assuming appropriate and standard filtering in the receiver (ref. [5] equation 11.45c). E_{b}/σ2 is, therefore, the signal-to-noise ratio per bit. (Note: Some references use a differing noise and quadrature transceiver definition whereby the noise affecting each bit has ½ the variance of the noise affecting the carrier—This difference does not effect performance viewed as a function of signal-to-noise ratio per bit.) From equation (18), looking at a single bit on the kth carrier:

$${x}_{{k}^{′}} [ n ] = \pm \frac{1}{\sqrt{2 N}} {ⅇ}^{\frac{j2π k n}{N}} + {n}_{{k}^{′}} [ n ] \qquad ( 23 )$$

This signal is then correlated to the appropriate complex exponential as shown in equation (21), resulting in Yₙ[k]:

$${Y}_{n} [ {k}^{′} ] = \pm \frac{N}{\sqrt{2 N}} + {\sum }_{n = 0}^{N - 1} {n}_{{k}^{′}} [ n ] {ⅇ}^{- \frac{j2π k n}{N}} \qquad ( 24 )$$

Because the samples of noise, n_{k′}[n], are independent and identically distributed, the summation term in equation (24) can be assumed to be a Gaussian distributed random variable with zero mean. All that remains is to determine the variance of this term. Since the variance of a complex random variable, x, is given by:

σₓ²=E{|x|²}−|E{x}|²=E{x·x^{*}}−|E{x}|² (25)

The variance desired can be derived:

$$\begin{matrix}\text{variance} \{ {\sum }_{n = 0}^{N - 1} {n}_{{k}^{′}} [ n ] {ⅇ}^{- \frac{j2π k n}{N}} \} = E \{ ( {\sum }_{n = 0}^{N - 1} {n}_{{k}^{′}} [ n ] {ⅇ}^{- \frac{j2π k n}{N}} ) \\ ( {\sum }_{l = 0}^{N - 1} {n}_{{k}^{′}}^{*} [ l ] {ⅇ}^{\frac{j2π k l}{N}} ) \} \\ = E \{ {\sum }_{l = 0}^{N - 1} {\sum }_{n = 0}^{N - 1} {n}_{{k}^{′}} [ n ] {n}_{{k}^{′}}^{*} [ l ] {ⅇ}^{- \frac{j2π k n}{N}} {ⅇ}^{\frac{j2π k l}{N}} \} \\ = {\sum }_{l = 0}^{N - 1} {\sum }_{n = 0}^{N - 1} E \{ {n}_{{k}^{′}} [ n ] {n}_{{k}^{′}}^{*} [ l ] \} {ⅇ}^{- \frac{j2π k n}{N}} {ⅇ}^{\frac{j2π k l}{N}} \\ = E \{ {n}_{{k}^{′}} [ n ] {n}_{{k}^{′}}^{*} [ l ] \} {\sum }_{l = 0}^{N - 1} {\sum }_{n = 0}^{N - 1} {ⅇ}^{- \frac{j2π k n}{N}} {ⅇ}^{\frac{j2π k l}{N}} \\ = {σ}^{2} δ ( n - l ) {\sum }_{l = 0}^{N - 1} {\sum }_{n = 0}^{N - 1} {ⅇ}^{- \frac{j2π k n}{N}} {ⅇ}^{\frac{j2π k l}{N}} \\ = {σ}^{2} {\sum }_{n = 0}^{N - 1} {ⅇ}^{- \frac{j2π k n}{N}} {ⅇ}^{\frac{j2π k n}{N}} = N {σ}^{2} = {E}_{s} {σ}^{2}\end{matrix} \qquad ( 26 )$$

The received signal can be related for a particular carrier and particular bit to the energy in the total signal. The transmitted (and, according to equation (24), received) quadrature component may be rewritten in terms of the total signal energy and total the number of bits transmitted:

received signal component per bit

$$\text{received signal component per bit} = \frac{N}{\sqrt{2 N}} = \frac{{E}_{s}}{\sqrt{\# bits}} \qquad ( 27 )$$

Equation (24), can be rewritten giving the final output of the FFT per bit in the presence of noise:

$${Y}_{n} [ {k}^{′} ] = \pm \frac{{E}_{s}}{\sqrt{\# bits}} + \text{noise} \\ \text{noise} \text{=>} \text{Gaussian, zero mean, variance} = {E}_{s} {σ}^{2} \qquad ( 28 )$$

With this information, the particular probabilities discussed above can be found—the probability that a transmitted zero bit exceeds a magnitude of T and that a transmitted {1} or {−1} bit falls below a magnitude of T in the receiver. For a Gaussian random variable with zero mean and variance=Nσ², it can be shown that the cumulative distribution is given by:

$$\begin{matrix}F ( T ) = \text{Probability} \{ noise \leq T \} = 1 - \frac{1}{2} erfc ( \frac{T}{\sqrt{2 {E}_{s}} σ} ) \\ \text{Since:} & ( 29 ) \\ Q ( T ) = \frac{1}{2} erfc ( \frac{T}{\sqrt{2}} ) & ( 30 )\end{matrix}$$

And the total probability must equal unity, the probability that the random variable, noise, exceeds a value, T can be defined:

$$\text{Probability} \{ noise \geq T \} = Q ( \frac{T}{\sqrt{N} σ} ) \qquad ( 31 )$$

Since the noise is a zero mean random variable and the Gaussian distribution is symmetric, the probability that the noise is a negative value less than −T is also given by equation (31). The probability, therefore, that the noise is of a high enough magnitude (either positive or negative) to cause a transmitted zero to appear to the receiver as being greater than T is:

$$\begin{matrix}\text{Probability that a transmitted zero bit} \\ \text{exceeds a magnitude of} \text{T}\end{matrix} = 2 Q ( \frac{T}{\sqrt{N} σ} ) \qquad ( 32 )$$

Similarly, the error probability for transmitted binary data (assuming equal probabilities of transmission for both {−1} and {1}) can be found:

$$\begin{matrix}\begin{matrix}\text{Probability that a transmitted} \\ \begin{matrix}\text{\{1\} or \{-1\} bit falls} \\ \text{below a magnitude of T}\end{matrix}\end{matrix} = P ( transmit \{ 1 \} ) \cdot P ( noise < ( T - \frac{N}{\sqrt{2 N}} ) ) + \\ P ( transmit \{ - 1 \} ) \cdot P ( noise > ( \frac{N}{\sqrt{2 N}} - T ) ) \\ = 0.5 \cdot Q ( \frac{\frac{N}{\sqrt{2 N}} - T}{\sqrt{N} σ} ) + 0.5 \cdot Q ( \frac{\frac{N}{\sqrt{2 N}} - T}{\sqrt{N} σ} ) \\ = Q ( \frac{1}{\sqrt{2} σ} - \frac{T}{\sqrt{N} σ} )\end{matrix} \qquad ( 33 )$$

An additional gain in performance can be derived by observing the peaks of the OFDM signal during unmapped vs. mapped transmission. The signal peaks always have a magnitude equal to the product of the PAPR and the average signal power. However, during unmapped symbol transmission, more than half of the transmitter input bits are zeroed out. This means that more than half of the bits are contributing no energy to the signal. The average power in these unmapped symbols will be less than half of the average power in the full symbol. Assuming that the PAPR with signal space expansion is comparable to the desired PAPR, the signal energy per bit may be increased by a factor of two (or more) without causing any saturation distortion or spectral regrowth in the power amplifier. This gives a significant increase in performance, and is quite simple to implement. The IFFT transmission circuitry simply need be modified to respond to the control logic and, during unmapped symbol transmission, use larger modulating coefficients—essentially bigger numbers at the inputs. Previously, it was stated that it is typical in transmitters to use the largest possible magnitude numbers for symbol transmission in order to maintain the best signal resolution. In this case, one may “backoff” the typical mapped symbols by a factor of 2^{0.5} (sacrificing less than one bit of signal resolution) and use the largest numbers possible only in sending unmapped symbols. Essentially, the unmapped signal input vectors per carrier will be:

$$X [ k ] = \pm \frac{N}{\sqrt{N}} \pm \frac{N}{\sqrt{N}} \qquad ( 34 )$$

This results in a modification to equation (28), giving the final output of the FFT per data carrying bit in the presence of noise:

$${Y}_{n} [ {k}^{′} ] = \pm \frac{\sqrt{2} {E}_{s}}{\sqrt{\# bits}} + noise \\ noise \text{=>} \text{Gaussian, zero mean, variance} = {E}_{s} {σ}^{2} \qquad ( 35 )$$

This has no effect on the probability of noise exceeding the threshold with zeroed bits, but it does decrease the probability that noise can corrupt transmitted data below the threshold for unmapped symbols since the signal is stronger.

$$\begin{matrix}\begin{matrix}\text{Probability that a transmitted \{1\}} \\ \text{or \{-1\} bit falls below a magnitude of} \text{T} \text{;} \\ \text{UNMAPPED CASE}\end{matrix} = P ( transmit \{ 1 \} ) \cdot P ( noise < ( T - \frac{N}{\sqrt{N}} ) ) + \\ P ( transmit \{ - 1 \} ) \cdot P ( noise > ( \frac{N}{\sqrt{N}} - T ) ) \\ = 0.5 \cdot Q ( \frac{\frac{N}{\sqrt{N}} - T}{\sqrt{N} σ} ) + 0.5 \cdot Q ( \frac{\frac{N}{\sqrt{N}} - T}{\sqrt{N} σ} ) \\ = Q ( \frac{1}{σ} - \frac{T}{\sqrt{N} σ} )\end{matrix} \qquad ( 36 )$$

The probability of the error, however, depends greatly on the number of bits observed in the threshold comparison groups. It is necessary to strictly define the parameters for transmission of unmapped user symbols. Assume that for a typical transmission (mapped symbols) one will send D user data bits and R redundant bits, such that N=(D+R)/2. It will further be assumed the following numbers of zeroed bits transmitted per unmapped symbol:

$$\begin{matrix}D even ⇒ \frac{D}{2} + R \text{zeroed bits} \\ D odd ⇒ \frac{D + 1}{2} + R \text{zeroed bits}\end{matrix} \} = Z \qquad ( 37 )$$

These represent the largest possible numbered comparison group and the common comparison group. The following are the number of user information carrying bits transmitted per unmapped symbol:

$$\begin{matrix}D even ⇒ \frac{D}{2} info bits \\ D odd ⇒ \frac{D - 1}{2} info bits\end{matrix} \} = I$$

These represent the alternate numbered comparison group (the smallest one). There are two choices for number of zeroed bits when D is odd because of the differing size of the numbered comparison groups and, also, there is some overlapping of zeroed bit positions between the two possible configurations of zero bits. There are some implementation choices to be made here about which bits will be observed to determine which type of symbol was sent. All bits need not be observed. Equation (37) & (38) give a set parameters for the analysis.

If more than half of the bits which are supposed to be zeroed are below the threshold, then it will be assumed that all of them are zeroed. (This includes a numbered comparison group and the common comparison group) If exactly half of the bits are below the threshold, then it will be assumed that a mapped symbol was transmitted, because mapped symbols are far more likely to be transmitted than unmapped symbols—meaning, it will be assumed that all of the bits contain information. The same procedure will be used for bits which should contain data. The majority will always determine the system's interpretation of a group of bits.

From equation (37) & (38), one can determine the number of zeroed bits and information bits that may be used as the parameters in the comparison groups:

$$\begin{matrix}\begin{matrix}Z even ⇒ Z / 2 \\ Z odd ⇒ ( Z + 1 ) / 2\end{matrix} \} = {Y}_{m} & ( 39 ) \\ \begin{matrix}I even ⇒ I / 2 \\ I odd ⇒ ( I + 1 ) / 2\end{matrix} \} = {H}_{m} & ( 40 )\end{matrix}$$

Therefore, Yₘ out of Z bits above the threshold or Hₘ out of I information bits falling below the threshold will qualify as a mapped transmission, in which case the assumption is that noise has corrupted an entire mapped symbol.

For error type 1, one can now calculate the probability of the two error conditions. First, there is a need to know the probability that Yₘ out of Z bits are above the threshold. Filling equation (32) into equation (A4) with the values from equation (37) & (39):

$$\begin{matrix} Probability \{ at least {Y}_{m} out \\ of Z bits exceed threshold \}\end{matrix} = 1 - {\sum }_{r = 0}^{{Y}_{m} - 1} b ( r ; Z , 2 Q ( \frac{T}{\sqrt{N} σ} ) ) \qquad ( 41 )$$

The second error condition for error type 1 is similarly given by filling equation (36) into equation (A4), with the values from equation (38) & (40):

$$\begin{matrix} Probability \{ at least \\ {H}_{m} out of I bits fall \\ below threshold \}\end{matrix} = 1 - {\sum }_{r = 0}^{{H}_{m} - 1} b ( r ; I , Q ( \frac{1}{σ} - \frac{T}{\sqrt{N} σ} ) ) \qquad ( 42 )$$

Because they are independent, the probability that both of these error conditions occur together is given by the product of equation (41) & (42):

$$\begin{matrix}\begin{matrix} Probability \\ \{ equ . 29 \& 30 \}\end{matrix} = [ 1 - {\sum }_{r = 0}^{{Y}_{m} - 1} b ( r ; Z , 2 Q ( \frac{T}{\sqrt{N} σ} ) ) ] \\ [ 1 - {\sum }_{r = 0}^{{H}_{m} - 1} b ( r ; I , Q ( \frac{1}{σ} - \frac{T}{\sqrt{N} σ} ) ) ]\end{matrix} \qquad ( 43 )$$

Therefore, filling equation (41), (42), & (43) into equation (A2) gives the total probability of error type 1, sending an unmapped symbol (zeroed bits) and receiving a full symbol (all bits used):

$$\begin{matrix}\begin{matrix} Probability \{ send \\ unmapped symbol \\ and receive \\ full symbol \}\end{matrix} = [ 1 - {\sum }_{r = 0}^{{Y}_{m} - 1} b ( r ; Z , 2 Q ( \frac{T}{\sqrt{N} σ} ) ) ] + \\ [ 1 - {\sum }_{r = 0}^{{H}_{m} - 1} b ( r ; I , Q ( \frac{1}{σ} - \frac{T}{\sqrt{N} σ} ) ) ] - \\ [ 1 - {\sum }_{r = 0}^{{Y}_{m} - 1} b ( r ; Z , 2 Q ( \frac{T}{\sqrt{N} σ} ) ) ] \\ [ 1 - {\sum }_{r = 0}^{{H}_{m} - 1} b ( r ; I , Q ( \frac{1}{σ} - \frac{T}{\sqrt{N} σ} ) ) ]\end{matrix} \qquad ( 44 )$$

If T is given as a function of the signal to noise ratio (N/σ²), then this equation gives an error probability as a function of signal to noise ratio. This can be used in combination with an optimization routine to obtain the optimal threshold for any particular system parameters. Trial and error, however, yields a reasonable threshold value in most cases. Recalling that alternation of transmitted blocks (alternation of FIFO outputs to transmitter) gives two possibilities for the above error to occur, but it is assumed that a decision has been made, previously, about which FIFO was to be the focus. Since each FIFO is equally likely to be sending data and each would maintain the same probability of error, equation (44) need not be modified further.

There are also other possible types of error.

Error Type 2: a mapped symbol (all bits used) is transmitted, but the receiver detects an unmapped symbol (zeroed bits). For this to occur, one of the numbered comparison groups (the one that has been theorized to contain zeroed bits) and the common comparison group must have a majority of data bits falling below the threshold while the alternate numbered comparison group has a majority of its bits exceeding the threshold.

In the case that a mapped symbol is transmitted, the following parameters are defined:

$$\begin{matrix}\begin{matrix} Z even ⇒ Z / 2 + 1 \\ Z odd ⇒ ( Z + 1 ) / 2\end{matrix} \} = {Y}_{u} & ( 45 ) \\ \begin{matrix} I even ⇒ I / 2 + 1 \\ I odd ⇒ ( I + 1 ) / 2\end{matrix} \} = {H}_{u} & ( 46 )\end{matrix}$$

Therefore, Yᵤ out of Z bits below the threshold together with Hᵤ out of I information bits remaining above the threshold will cause erroneous detection of an unmapped symbol.

The numbers presented in equation (37) & (38) are held in order to obtain an accurate total error equation. It is assumed that the numbers given for Z represent the bits that need to be corrupted by noise to fall below the threshold, and the numbers for I represent the bits that must remain above the threshold for this type of error to occur. The probability of the first condition's occurrence is given by filling equation (33) into equation (A4) and using the numbers from equation (37) & (45):

$$\begin{matrix} Probability \\ \{ magnitude of at \\ least {Y}_{u} out of \\ Z information \\ bits < T \}\end{matrix} = 1 - {\sum }_{r = 0}^{{Y}_{u} - 1} b ( r ; Z , Q ( \frac{1}{\sqrt{2} σ} - \frac{T}{\sqrt{N} σ} ) ) \qquad ( 47 )$$

The probability of the second condition's occurrence may be obtained from equation (33) (the opposite probability that is desired) and equation (A4) using the numbers from equation (38) & (46):

$$\begin{matrix} Probability \\ \{ magnitude of \\ at least {H}_{u} out \\ of I \\ information \\ bits > T \}\end{matrix} = 1 - {\sum }_{r = 0}^{{H}_{u} - 1} b ( r ; Z , [ 1 - Q ( \frac{1}{\sqrt{2} σ} - \frac{T}{\sqrt{N} σ} ) ] ) \qquad ( 48 )$$

Because the two events are independent, the probability of both of them happening together is given by the product of the individual probabilities. This is the final result for error type 2:

$$\begin{matrix}\begin{matrix} Probability \\ \{ send \\ mapped \\ symbol and \\ receive \\ unmapped \\ symbol \}\end{matrix} = [ 1 - {\sum }_{r = 0}^{{Y}_{u} - 1} b ( r ; Z , Q ( \frac{1}{\sqrt{2} σ} - \frac{T}{\sqrt{N} σ} ) ) ] \\ [ 1 - {\sum }_{r = 0}^{{H}_{u} - 1} b ( r ; Z , [ 1 - Q ( \frac{1}{\sqrt{2} σ} - \frac{T}{\sqrt{N} σ} ) ] ) ]\end{matrix} \qquad ( 49 )$$

Finally, the total probability of error due to the Block Segmentation Procedure is:

$$\begin{matrix}Probability \{ error due to Block Segmentation \} = \\ P \{ send unmapped \} P \{ send unmapped , rcv mapped \} + P \{ send mapped \} P \{ send mapped , rcv unmapped \} = \\ \frac{U}{{2}^{D}} * [ equation 32 ] + ( 1 - \frac{U}{{2}^{D}} ) * [ equation 37 ] ; U = \# unmapped symbols in user symbol space\end{matrix} \qquad ( 50 )$$

The probability of symbol error for straight OFDM may also be derived in order to compare the technique. Typically, the sign of the correlator output determines which bit was transmitted for OFDM. Therefore, as was derived for equation (33):

Probability that a transmitted {1} or {−1} bit falls below a magnitude of 0 (changes sign)

$$\begin{matrix}\begin{matrix} Probability that \\ a transmitted \\ \{ 1 \} or \{ - 1 \} bit \\ falls below a \\ magnitude \\ of 0 \\ ( changes sign )\end{matrix} = P ( transmit \{ 1 \} ) \cdot P ( noise < ( - \frac{N}{\sqrt{2 N}} ) ) + \\ P ( transmit \{ - 1 \} ) \cdot P ( noise > ( \frac{N}{\sqrt{2 N}} ) ) \\ = 0.5 \cdot Q ( \frac{\frac{N}{\sqrt{2 N}}}{\sqrt{N} σ} ) + 0.5 \cdot Q ( \frac{\frac{N}{\sqrt{2 N}}}{\sqrt{N} σ} ) \\ = Q ( \frac{1}{\sqrt{2} σ} ) \\ \begin{matrix} OFDM Probability \\ of bit error\end{matrix} = Q ( \sqrt{\frac{{E}_{b}}{{σ}^{2}}} ) \\ = Q ( \sqrt{\frac{Signal}{Noise} per bit} )\end{matrix} \qquad ( 51 )$$

From equation (51) and the independence of carriers, the probability of all 2N bits comprising an OFDM symbol being demodulated correctly is equivalent to the probability that there is no bit error in the 2N positions:

Probability Symbol Demodulated Correctly

$$\begin{matrix} Probability Symbol \\ Demodulated \\ Correctly\end{matrix} = {( 1 - Q ( \sqrt{\frac{{E}_{b}}{{σ}^{2}}} ) )}^{2 N} \qquad ( 52 )$$

Therefore, the probability of a symbol error is:

OFDM Probability of Symbol Error

$$\begin{matrix}OFDM Probability of \\ Symbol Error\end{matrix} = 1 - {( 1 - Q ( \sqrt{\frac{{E}_{b}}{{σ}^{2}}} ) )}^{2 N} \qquad ( 53 )$$

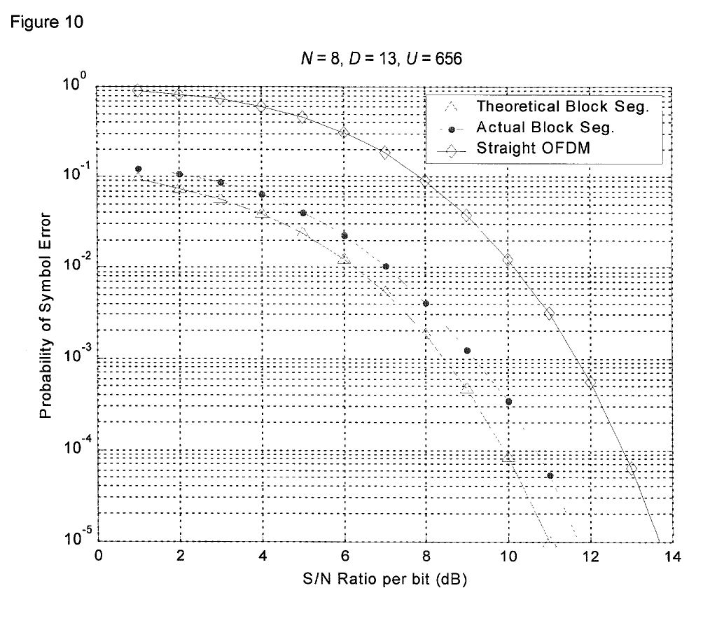

FIG. 10, gives a comparison of OFDM symbol error rate to the errors caused by the addition of Block Segmentation. With Block Segmentation errors nearly two orders of magnitude below those inherent to OFDM for any particular S/N ratio, the OFDM errors will dominate the total error rate. This means that the increase in error rate due to the addition of Block Segmentation to a system is negligible. Block Segmentation costs nothing in performance. The only consideration left is the increase in signal energy required to accommodate the redundant bits. As discussed above, all coding schemes suffer the same effect, and this procedure approaches the limit in redundancy vs. PAPR reduction.

Additionally, it should be noted that the performance increase achieved by doubling the signal energy per bit during unmapped symbol transmission is not pivotal to correct system operation with the segmentation architecture shown here. This design is robust even without the temporary increase in E_{b}/σ². However, the OFDM data transmissions themselves (not considered in the block segmentation plot) do benefit, often significantly, from the performance increase. The effect of a 3 dB increase in transmitted signal-to-noise ratio on the OFDM symbol error rate can also be seen in FIG. 10. This increase would affect unmapped symbols only and should be weighted accordingly.

Another possible unmapped symbol detection method would be to sum over all of the carriers in a comparison group and then compare to a threshold to determine the trend (whether to {0} or to {1,−1}). This method could be carried out in hardware using a Finite Impulse Response (FIR) filter with all coefficients set to a constant and the input taps connected to the receiver's output bits. However, the additional hardware necessary to add the receiver outputs together would be slower than simply comparing each bit to a threshold. Addition cannot be carried out in parallel, as threshold comparison can. Therefore, this possibility was not investigated further, though it may be usable in practice.

Furthermore, although it is not taken into account in the error analysis, most modern communication systems incorporate error detection/correction coding of some form into the transmitted data stream. Taking advantage of this coding would most likely cause a significant increase in performance since the unmapped symbol detection scheme is dependent on only a majority of bits being correctly demodulated. The coding inherent to any transmission should greatly increase the likelihood of a majority of bits being correctly demodulated. More importantly, all data synchronization depends on some type of coding scheme or “framing” system for ensuring that the data stream integrity is maintained. This is especially important in a block segmentation system, since unmapped symbol detection errors can result in segment-length time shifts of the data stream. These can wreak havoc with proper data reception if there is no method in place to guarantee data integrity.

Finally, it should be mentioned that the reason multiple detection conditions have been placed on unmapped transmissions is because it is sought to avoid the problem of detecting two unmapped symbols in the receiver. Alternatively, one could simply detect whether the bits in a numbered comparison group are below the threshold and, if so, assume that the opposite numbered comparison group contains the true information and load that data into the corresponding FIFO. However, because one is not only detecting the presence of an unmapped symbol, but also the position (two possibilities because of alternation), there is the possibility that both numbered comparison groups fall below the threshold and both force the opposite group to push data into the FIFO's. This will result in errors if the unmapped data is not contained in the same bit positions as the mapped data (for example, redundant peak reduction information may be put into the FIFO's as data). In systems where the unmapped and mapped data occupy the same bit positions (such as the staggered configuration shown in FIG. 9), detection may be simplified and performance will most likely increase. The analysis, above, is for the most general case.

Feasibility

Storage requirements for the peak reduction bits limit that procedure's feasibility to N=8-16. This is a function of the speed and size of current day storage devices. For N=16 with 4 redundant bits (12.5%), 2²⁸*5 bits of storage space are required. (# user combinations multiplied by 4 redundant plus one segmentation bit) This is equivalent to 1.25 Gbytes of space (1 Gbyte=2³⁰ bits). Any storage requirement above 1 Gbyte requires hard-disk type storage (or high expense). The latency in accessing the information is typically in the millisecond range and, therefore, too slow for providing symbol-by-symbol information in a typical OFDM system. A low number of carriers is best for implementing this procedure efficiently. For example, N=16 with 6 redundant bits requires a storage space of 448 Mbytes (1 Mbyte=2ˆ 20 bits)—a more reasonable storage requirement for memory devices.

Some would question the usefulness of a low carrier procedure. Larger values of N do not give better redundancy vs. PAPR tradeoffs. Furthermore, because of the increasing storage requirements necessary with increasing FFT size, the difficulty in obtaining the optimal PAPR vs. data rate tradeoff usually makes the system impractical. Instead, a sub-optimal PAPR is obtained for larger values of N, sometimes dependent on additional overhead in terms of redundant carriers used for communication between the receiver and transmitter about what kind of transmit mapping has been implemented. These systems rely on computational power in the transmitter and receiver (as opposed to computation during the design phase, as is required with the augmented reduction coefficient method presented here) which can reduce throughput, increase power consumption, and greatly increase the cost—nullifying the perceived advantages of a larger FFT size. This is not meant to imply that such systems are not useful, but simply to point out that they may not always be useful under the same conditions applied to low FFT size transmitters. Therefore, assuming that uncontrollable factors such as delay spread, do not drive the choice of symbol period (and hence, FFT size), there are certainly places in the spectrum of digital communication where lower FFT sizes are useful.

Block Segmentation-Other Applications

The results shown here represent a mere fraction of the Block Segmentation Procedure's potential. Block Segmentation provides a hardware efficient method of transmitting OFDM symbols such that their PAPR is significantly reduced (because of average power reduction and symbol space expansion) while maintaining error performance. It gives the option of using a full OFDM transmission or efficiently switching to a method which is less taxing on the power amplifier stage. Feedback from the IFFT output to the transmitter control logic could be used to determine when switching is required (by observing the peak signal value). With the continually higher FFT speeds available, this feedback should not compromise the throughput of the signal. Therefore, though tailored around peak reduction coefficients in this document, Block Segmentation can improve any coding scheme (including no coding at all). Whatever the PAPR reduction provided by the particular coding scheme used, a further gain will be achieved by virtue of Block Segmentation's ability to deal with the fraction of the symbol space which is resistant to PAPR reduction through conventional methods. The fraction of the symbol space could be as large as ½, and Block Segmentation would still yield very effective results. (One half of the symbol space would be transmitted with one FFT while the other half would be transmitted with 1.5 FFT's—two-segment case.)

It is believed that any number of carriers may be used in combination with Block Segmentation. Block Segmentation may be used with any block size, or any number of blocks per symbol. For larger number of carriers, the blocks would simply carry a smaller percentage of the total symbol in order to accommodate the user's PAPR requirements. It is quite feasible to send only those symbols with low PAPR using conventional OFDM, and send high PAPR symbols using Block Segmentation, easily meeting PAPR requirements because of the reduction in average power gained through segmentation.Note the large dropoff in PAPR for merely one bit of redundancy. This means that there is a 50% chance that a transmitted symbol will have a relatively low PAPR. In order to take advantage of this inherent OFDM signal characteristic, the high-PAPR half of the symbol space would need to be detected as too high (using feedback from the IFFT output prior to the power amplifier stage) and transmitted using some other method which could reduce the PAPR, maintain the error rate, and not be overly harsh on throughput. Could Block Segmentation be the solution?

The Block Segmentation Procedure can augment the PAPR reduction provided by peak reduction coefficients (limited to user input specifications) greatly, reducing the need for such an exhaustive initial symbol search required for phase and amplitude modulation. The results obtained for the system's performance indicate that the limits given in Lawrey are being approached. This system can be implemented for N=4-16 and is simple enough using current technology. For small increases in logic hardware complexity, one can reduce cost in the power amplifier stage significantly. The key difficulties in implementing this type of system come during the design phase. Once alternatives are investigated and decisions about implementation are made, the system hardware itself is quite efficient.

More importantly, Block Segmentation has certain advantages in and of itself (without application to peak reduction coefficients):

a. Here, the Block Segmentation Procedure approaches reductions in PAPR which are close to the absolute limit with straight coding. The tradeoff between data rate and PAPR reduction for Block Segmentation can be very efficient. Block Segmentation is tailored to OFDM because of the nature of the OFDM signal's PAPR. Most coding schemes work on all symbols (including those whose PAPR does not require an adjustment), guaranteeing only a flat maximum PAPR, but, typically, only small groups of symbols are the root cause of a PAPR problem. Block Segmentation is custom-fit to this concept and adjusts only the symbols that need PAPR reduction, in all cases. The reduction in data rate needed to accomplish this will not always be acceptable, but the results given in this document certainly imply that there are conditions under which the reduction in data rate is quite efficient. For the two-segment case, only a time penalty of ½ a symbol period is incurred in order to transmit the high PAPR user symbols. Block Segmentation, for any number of segments, never incurs more than a single symbol period time penalty because of the method of “packing” the user data as tightly as possible to make the most of the transmitted symbols. This mixing of segments from different user blocks in the transmissions is a source of the method's efficiency.

b. Block Segmentation requires little increase in hardware over conventional OFDM transmission schemes. The key increase in hardware complexity is due to added memory in terms of the multiple segment FIFO's.

c. In general, Block Segmentation allows for much finer control over the maximum PAPR vs. data rate reduction tradeoff than can be attained with any coding scheme.

d. Block Segmentation has the potential to be applied to any number of OFDM carriers, with or without coding. This is not true of many PAPR reduction schemes.

e. Block Segmentation, in and of itself, has a negligible error rate because reception depends on accurate demodulation of a majority of bits rather than particular sequences or any one bit. This allows for the addition of Block Segmentation to any system without degradation in error performance.

f. Block Segmentation yields relatively good overall performance with unmapped symbol probabilities as high as ½. Block Segmentation, therefore, is capable of tolerating a high PAPR as much as every other symbol transmission.

All PAPR values discussed herein are rounded up on the third digit after the decimal point or however many digits are necessary to distinguish distinct PAPR values. It is, therefore, always possible to achieve the same or lower PAPR value as the one mentioned here.

[image]

[image]

[image]

### REFERENCES

1. Simon Shepard, John Oriss, and Stephen Barton. “Asymptotic Limits in Peak Envelope Power Reduction by Redundant Coding in Orthogonal Frequency-Division Multiplex Modulation”. IEEE Transactions Communications, Vol. 46, No. 1, January 1998.

2. E. Lawrey and C. J. Kikkert. “Peak to Average Power Ratio Reduction of OFDM Signals Using Peak Reduction Carriers”. Fifth International Symposium on signal processing and its applications, ISSPA '99, Brisbane, Australia, Aug. 22-25, 1999

3. P. W. J. Van Eetvelt, S. J. Shepherd, and S. K. Barton. “The Distribution of Peak Factor in QPSK Multi-Carrier Modulation”. Wireless Personal Communications (Kluwer Academic Press), vol. 2, November 1995

4. Atsushi Sumasu, Toyoki U E, Mitsuru Uesugi, Osamu Kato, and Koichi Homma. “A Method to Reduce the Peak Power with Signal Space Expansion (ESPAR) for OFDM System”. Vehicular Technology Conference Proceedings 2000, IEEE 51^{st}

5. Lathi, B. P. Modern Analog and Digital Communication Systems. 3^{rd} Edition, Oxford University Press, Inc. 1998

6. Papoulis, Athanasios. Probability, Random Variables, and Statistics. 3^{rd} Edition, McGraw-Hill, Inc. 1991

7. Proakis, John G. Digital Communications. 3^{rd} Edition, McGraw Hill, Inc. 1995

8. Porat, Boaz. A Course in Digital Signal Processing. John Wiley & Sons, Inc. 1997.

9. Ronald Walpole and Raymond H. Myers. Probability and Statistics for Engineers and Scientists. Fifth edition, Macmillan Publishing Company, 1993.

I claim:

1. An apparatus for transmitting user data blocks comprising a means for comparing the peak output of a transmission data block to a constant based on the dynamic range of a power amplifier, a means for dividing any transmission data block that has a peak output greater than the chosen constant into two or more segments, a transmitter for transmitting said segments individually to a receiver.

2. The apparatus according to claim 1 wherein one or more indicators are provided to notify the receiver that the original transmission data block should be reconstructed from said segments.

3. The apparatus according to claim 2 wherein there is a distinction between the signal representation used for the indicators and that used for the data being transmitted.

4. The apparatus according to claim 3 wherein the data is binary and the indicator is non binary.

5. The apparatus according to claim 4 wherein said indicator is a 0 when the data is comprised of +1's and −1's.

6. The apparatus according to claim 2 wherein the segments are transmitted in a transmission data block and said indicators may be included in said data block.

7. The apparatus according to claim 6 wherein when one or more segments are interspersed with indicators, the total amount of information must fill a full transmission data block.

8. The apparatus according to claim 1 wherein two or more segments from different user data blocks may be transmitted together, in the same transmission data block.

9. The apparatus according to claim 8 wherein the segments comprising the transmitted data block are selected in a cyclic order.

10. The apparatus according to claim 9 wherein said receiver is adapted to reconstruct user data blocks based on said indicator.

11. The apparatus according to claim 10 wherein said receiver may also reconstruct user data blocks based on the order in which said segments are transmitted.

12. The apparatus according to claim 11 wherein when one of the divided segments from a user data block is transmitted along with indicator information as a single transmission data block, the next transmission data block comprises the remaining segment or segments without indicators.

13. The apparatus according to claim 12 wherein the next data block to be transmitted further includes one or more segments from another user data block.

14. The apparatus according to claim 1 wherein the transmitter is adapted such that all segments separated from said user data blocks have a power output less than the dynamic range of said power amplifier.

15. The apparatus according to claim 2 wherein said segments are defined by bit positions selected from said user data blocks and determine bit positions in transmitted data blocks.

16. The apparatus according to claim 15 wherein said indicators, when used, are placed in predetermined positions in transmitted data blocks.

17. The apparatus according to claim 16 wherein a majority of the indicators in said transmitted data blocks constitute a means for a receiver to diminish the effects of receive errors.

18. The apparatus according to claim 17 wherein groups of segments may be compared by a receiver to determine the type of indicator(s) transmitted, if any.

19. The apparatus according to claim 18 wherein the comparison groups are determined by the bit positions of said segments.

20. The apparatus according to claim 8 wherein there is an independent memory means for each of said segments in a data block.

21. The apparatus according to claim 1 wherein bus switches control the placement of indicators and data within the transmission data block and the routing of received data.

22. A system for reduction of Peak-to-Average Power Ratio Effects in Orthogonal Frequency-Division Multiplexing Modulation comprising
(a) a means for determining which symbols in the transmitted symbol space have a PAPR less than some set constant;
(b) a means for determining which symbols in a symbol space have a PAPR greater than said constant;
(c) for the symbols in the symbol space that are greater than the constant, a transmitter adapted to transmit only a part of the information bits at a time, said transmitter interspersing zeroes between those information bits to segregate the bits into blocks;
(d) whenever PAPR requirements can be met, a means of packing transmitted symbols to capacity with user information, without destroying the order of user information at the output of the receiver;
(e) a receiver adapted to analyze comparison groups to determine which received bit positions contain user data and which contain zeroes.

23. A system for reduction of Peak-to-Average Power Ratio Effects in Orthogonal Frequency-Division Multiplexing Modulation comprising a transmitter for transmitting an OFDM signal, one or more amplifier stages, and a receiver for demodulating said signal, further comprising
(a) a means for determining which symbols in the transmitted symbol space have a PAPR less than some set constant;
(b) a means for determining which symbols in a symbol space have a PAPR greater than said constant;
(c) for the symbols in the symbol space that are greater than the constant, a transmitter adapted to transmit only a part of the information bits at a time, said transmitter interspersing zeroes between those information bits to segregate the bits into blocks;
(d) whenever PAPR requirements can be met, a means of packing transmitted symbols to capacity with user information, without destroying the order of user information at the output of the receiver;
(e) a receiver adapted to analyze comparison groups to determine which received bit positions contain user data and which contain zeroes.

24. The system according to claim 23 wherein an Inverse Fast Fourier Transform is used to create the OFDM signal and the Fast Fourier Transform is used to demodulate the OFDM signal.
